(19) United States
(12) Patent Application Publication
(10) Pub. No.: US 2016/0335495 A1
(43) Pub. Date: Nov. 17, 2016

(54) APPARATUS AND METHOD FOR ACQUIRING IMAGE FOR IRIS RECOGNITION USING DISTANCE OF FACIAL FEATURE

(71) Applicants: Dae Hoon KIM, Seoul (KR); IRITECH, INC., Fairfax, VA (US)

(72) Inventors: Dae Hoon KIM, Seoul (KR); Hyeong In CHOI, Seoul (KR); Byung Jin JUN, Seoul (KR); Thi Thanh Tuyen NGUYEN, Seoul (KR); Su Jin CHOI, Seoul (KR); Haeng Moon KIM, Gwacheon-si (KR)

(21) Appl. No.: 15/109,435

(22) PCT Filed: Dec. 30, 2014
(86) PCT No.: PCT/KR2014/013022

§ 371 Date: Jun. 30, 2016

(30) Foreign Application Priority Data
Jan. 2, 2014 (KR) 10-2014-0000160

(51) Int. Cl. G06K 9/00

(52) U.S. Cl. CPC G06K 9/00604; G06K 9/00248; G06K 9/00281; G06K 9/00919; G06K 9/0061

(57) ABSTRACT

The present invention relates to an apparatus and method for acquiring an image for iris recognition using a distance of a facial feature, the apparatus comprising: a buffer for photographing one or more facial images of a subject being photographed so as to acquire an image for iris recognition and storing the photographed facial images; a facial feature distance calculating unit for calculating a distance of a facial feature from the facial images stored in the buffer; an actual distance estimating unit for estimating an actual distance between the subject being photographed and a camera from the distance of the face feature calculated by the facial feature distance calculating unit, and confirming, from of the estimated distance, that the subject being photographed exists in an iris photographing space; and an iris image acquiring unit for acquiring an eye image from the facial images of the subject being photographed that has been confirmed as existing in the iris photographing space by the actual distance estimating unit, and measuring the quality of the acquired eye image so as to acquire an image for iris recognition, which satisfies a reference level of quality.

### TECHNICAL FIELD

The present invention relates to a system and method for acquiring an iris image for iris recognition by using a facial component distance. More particularly, the present invention relates to a system for acquiring an iris image for iris recognition by using a facial component distance, the system including a buffer for storing at least one face image of a subject photographed by a camera so as to acquire an image for iris recognition, a facial component distance calculation unit for calculating a facial component distance from the face image stored in the buffer, an actual distance estimation unit for estimating the actual distance between the subject and the camera from the facial component distance calculated by the facial component distance calculation unit and for determining based on the estimated distance whether the subject is in an iris photographing volume, and an iris image acquisition unit for acquiring an eye image from the face image of the subject determined to be in the iris photographing volume by the actual distance estimation unit and for measuring the quality of the acquired eye image to acquire an image for iris recognition that satisfies a reference quality level, and a method of acquiring an iris image for iris recognition by using a facial component distance, the method being performed by the system.

### BACKGROUND ART

In general, iris recognition is a method of extracting an iris from an image of a subject and comparing the extracted iris of the subject with an iris extracted from another image to verify or identify the subject. In such iris recognition, it is most important to acquire a sharp iris image while maximizing the comfort of the subject.

In order to acquire a sharp iris image, it is required that the eyes of the subject be within the angle of view of a camera for iris recognition and within a focal distance. To this end, various methods have been attempted.

One of the conventional methods that have been most frequently used is to photograph a subject in the state in which the subject is stationary after the subject moves a predetermined distance while directly viewing the screen. In this method, however, it is not possible to photograph the subject without the active participation of the subject. In addition, the quality of an iris image is variable depending on the skill of the subject.

Other conventional representative methods that are capable of solving the problems caused in the above conventional method are to measure the distance to a subject using a distance measurement sensor and to measure the positions of the eyes of a subject using multiple cameras.

A conventional method of measuring the distance to a subject using a distance measurement sensor to automatically focus a camera, which is related to the present invention, is disclosed in Korean Patent Application Publication No. P 2002-0086977 and No. P 2002-0073653.

In the disclosure of Korean Patent Application Publication No. P 2002-0086977 and No. P 2002-0073653, a face image obtained by projecting an infrared spot beam on the face of a subject using an infrared spot beam type distance measurement pointer so as to measure the distance between a subject and a camera for iris recognition is analyzed to calculate the distance between the subject and the camera for iris recognition. In this method, the spot beam projection device and the distance measurement sensor are further provided. However, it is difficult to mount these devices in electronic equipment, such as a smart phone, which has been miniaturized in recent years, due to the increase of costs and spatial limitations.

Another conventional method of measuring the positions of the eyes of a subject and photographing an iris image of the subject using two or more cameras, which is related to the present invention, is disclosed in Korean Patent Application Publication No. 10-2006-0081380.

Korean Patent Application Publication No. 10-2006-0081380, which relates to the acquisition of a stereoscopic iris image using two or more cameras mounted in a mobile terminal in a state of being focused, may solve the problems caused in the above-mentioned patent application publication. However, the volume of the mobile terminal is increased along with the increase of manufacturing costs because the stereo cameras are mounted in the mobile terminal. In addition, it is necessary to mechanically and electrically drive the respective cameras, with the result that the construction of the system is complicated.

A further conventional method related to the present invention is disclosed in Korean Patent Application Publication No. 10-2013-0123859. In the disclosure of Korean Patent Application Publication No. 10-2013-0123859, no additional infrared lighting is added to a terminal, light reflected from an external subject is collected using a proximity sensor mounted in the terminal, and the collected light is analyzed to measure the distance to the external subject, as described in the specification of the present application. In this method, an iris image of the subject is photographed using a general digital (color) camera, without using infrared lighting. However, beams reflected from surrounding objects (things) are concentrated on the iris image of the subject, with the result that the iris image is covered, whereby the precision of iris recognition is reduced. In addition, the reliability of distance measurement is reduced due to surrounding lighting and reflected light.

In recent years, research has been conducted into the application of iris recognition to various devices that have not been considered to date. Specifically, research has been actively conducted into the application of iris recognition to entrance security devices, such as door locks, other security devices, such as closed-circuit televisions (CCTVs), imaging devices, such as cameras, video players, and camcorders, and smart devices, such as smart phones, personal digital assistants (PDAs), personal computers (PCs), and laptop computers. In particular, terminals, such as smart phones, have very rapidly become intelligent.

In addition, cameras mounted in terminals, such as smart phones, have been very rapidly developed. In recent years, low-priced camera modules for smart phones having a resolution of 12M or 16M pixels and a transfer rate of 30 or more frames per second have been used, and low-priced devices using camera modules having higher resolutions and higher frame transfer rates are expected to be commonly used in a short time.

Therefore, there is a high necessary for a technical system and method that are capable of solving the above-mentioned problems, improving user convenience while sufficiently considering problems related to physical spaces and costs, and easily applying iris recognition to entrance security devices, such as door locks, other security devices, such as CCTVs, imaging devices, such as cameras, video players, and camcorders, and smart devices, such as smart phones, PDAs, PCs, and laptop computers.

### DISCLOSURE

### Technical Problem

Therefore, the present invention has been made in view of the above problems, and it is an object of the present invention to acquire an image for iris recognition from an image photographed using a camera in a conventional device using a facial component distance without using a conventional complex distance measurement system and method which are conventionally used to acquire a sharp iris image.

It is another object of the present invention to estimate the actual distance between a camera and a subject, thereby acquiring an image for iris recognition at a position at which an optimal image can be acquired, which is set differently based on the kind of device.

It is another object of the present invention to separate an image including an iris zone from an image photographed using a camera in a conventional device and to measure quality items, thereby acquiring an image for iris recognition that satisfies a predetermined quality level.

It is another object of the present invention to provide a guide that a subject can intuitively recognize without using a conventional complex and difficult method of guiding the subject so as to approach a position at which an optimal image can be acquired or to provide an actuator in the camera such that the camera can automatically move in the state in which the subject is stationary, thereby improving the convenience of the subject.

It is another object of the present invention to acquire an image for iris recognition at a position at which an optimal image can be acquired, thereby optimizing the efficiency in usage of power and resources of conventional devices.

It is another object of the present invention to extract a facial component distance by using a face recognition or eye-tracking technique without using a conventional method so as to prevent a fake image from being acquired as an image for iris recognition.

It is a further object of the present invention to additionally use an image photographed using a conventional device for face recognition so as to acquire an image for iris recognition or to perform iris recognition using the image for iris recognition, thereby making it easy to unlock devices or to improve the security of the devices.

### Technical Solution

In accordance with an aspect of the present invention, the above and other objects can be accomplished by the provision of a system for acquiring an iris image for iris recognition by using a facial component distance, the system including a buffer for storing at least one face image of a subject photographed by a camera so as to acquire an image for iris recognition, a facial component distance calculation unit for calculating a facial component distance from the face image stored in the buffer, an actual distance estimation unit for estimating the actual distance between the subject and the camera from the facial component distance calculated by the facial component distance calculation unit and for determining based on the estimated distance whether the subject is in an iris photographing volume, and an iris image acquisition unit for acquiring an eye image from the face image of the subject determined to be in the iris photographing volume by the actual distance estimation unit and for measuring the quality of the acquired eye image to acquire an image for iris recognition that satisfies a reference quality level, and a method of acquiring an iris image for iris recognition by using a facial component distance, the method being performed by the system.

In accordance with another aspect of the present invention, there is provided a system for acquiring an iris image for iris recognition by using a facial component distance, the system further including an actual distance calculation unit for calculating the actual distance between the subject and the camera using a function describing the relationship between the facial component distance and the actual distance between the subject and the camera acquired through prior experimentation and stored in a memory or a database of a computer or a terminal and an iris photographing volume determination unit for determining, from the calculated actual distance between the subject and the camera, whether the subject is in the iris photographing volume and, if so, informing the iris image acquisition unit that the subject is in the iris photographing volume, and a method of acquiring an iris image for iris recognition by using a facial component distance, the method being performed by the system.

In accordance with another aspect of the present invention, there is provided a system for acquiring an iris image for iris recognition by using a facial component distance, the system further including an eye image extraction unit for extracting eye images of the left eye and the right eye from the face image photographed in the iris photographing volume and stored in the buffer, an eye image storage unit for separately storing the extracted eye images of the left eye and the right eye, and an eye image quality measurement unit for measuring the quality of the stored eye images of the left eye and the right eye, determining whether the measured quality of the eye images satisfies the reference quality level, and, if so, acquiring the eye images the quality of which satisfies the reference quality level as images for iris recognition, and a method of acquiring an iris image for iris recognition by using a facial component distance, the method being performed by the system.

In accordance with another aspect of the present invention, there is provided a system for acquiring an iris image for iris recognition by using a facial component distance, the system further including an intuitive image guide unit for providing a made-up image guide to guide the subject so as to enter the iris photographing volume or an actuator controller for controlling an actuator of the camera, which is added to the iris photographing volume determination unit, and a method of acquiring an iris image for iris recognition by using the facial component distance, the method being performed by the system.

In accordance with a further aspect of the present invention, there is provided a system for acquiring an iris image for iris recognition by using a facial component distance, the system further including a face recognition unit for performing face recognition while the facial component elements are being extracted in order to measure the facial component distance and an iris recognition unit for performing iris recognition by using the images for iris recognition, and a method of acquiring an iris image for iris recognition by using the facial component distance, the method being performed by the system.

### Advantageous Effects

The present invention has been made in view of the above problems, and the present invention has the effect of acquiring an image for iris recognition from an image photographed using a camera in a conventional device using a facial component distance without using a conventional complex distance measurement system and method which are conventionally used to acquire a sharp iris image.

In addition, the present invention has the effect of estimating the actual distance between a camera and a subject, thereby acquiring an image for iris recognition at a position at which an optimal image can be acquired, which is set differently based on the kind of device.

In addition, the present invention has the effect of separating an image including an iris zone from an image photographed using a camera in a conventional device and measuring quality items, thereby acquiring an image for iris recognition that satisfies a predetermined quality level.

In addition, the present invention has the effect of providing a guide that a subject can intuitively recognize without using a conventional complex and difficult method of guiding the subject so as to approach a position at which an optimal image can be acquired or providing an actuator in the camera such that the camera can automatically move in the state in which the subject is stationary, thereby improving the convenience of the subject.

In addition, the present invention has the effect of acquiring an image for iris recognition at a position at which an optimal image can be acquired, thereby optimizing the efficiency in usage of power and resources of conventional devices.

In addition, the present invention has the effect of extracting a facial component distance by using a face recognition or eye-tracking technique without using a conventional method so as to prevent a fake image from being acquired as an image for iris recognition.

In addition, the present invention has the effect of additionally using an image photographed using a conventional device for face recognition so as to acquire an image for iris recognition or performing iris recognition using the image for iris recognition, thereby making it easy to unlock devices or to improve the security of the devices.

### DESCRIPTION OF DRAWINGS

FIG. 1 is a view showing various illustrations of the distances between facial component elements according to an embodiment of the present invention;

FIG. 2 is a view showing an illustration of the distance between the left eye and the right eye, which may be variously measured based on the positions of reference points according to an embodiment of the present invention;

FIG. 3 is a block diagram schematically showing a system for acquiring an iris image for iris recognition by using a facial component distance according to an embodiment of the present invention;

FIG. 4 is a flowchart illustrating a method of acquiring an iris image for iris recognition by using a facial component distance according to an embodiment of the present invention;

FIG. 5 is a block diagram schematically showing a facial component distance calculation unit according to an embodiment of the present invention;

FIG. 6 is a flowchart illustrating a method of calculating a facial component distance according to an embodiment of the present invention;

FIG. 7 is a block diagram schematically showing an actual distance estimation unit according to an embodiment of the present invention;

FIG. 8 is a view showing an illustration of the principle of a pinhole camera model indicating the relationship between a facial component distance and an actual distance according to an embodiment of the present invention;

FIG. 9 is a view showing an illustration of the principle of obtaining a function describing the relationship between a facial component distance and an actual distance by using a statistical means (mainly, regression analysis) according to an embodiment of the present invention;

FIG. 10 is a view showing an illustration of the principle of obtaining a function describing the relationship between a facial component distance and the actual distance between a subject and a camera estimated by using an interpupillary distance as a facial component distance according to an embodiment of the present invention;

FIG. 11 is a view showing an illustration, using the screen of a smart phone, of a method of a guide unit according to an embodiment of the present invention informing a subject that the subject has approached an iris photographing volume by using an intuitive image guide;

FIG. 12 is a block diagram schematically showing an iris image acquisition unit according to an embodiment of the present invention;

FIG. 13 is a flowchart illustrating a method of acquiring images for iris recognition according to an embodiment of the present invention;

FIG. 14 is a view showing an illustration of the principle of extracting eye images from face images photographed in an iris photographing volume according to an embodiment of the present invention;

FIG. 15 is a view showing an illustration of the principle of extracting eye images from face images photographed in an iris photographing volume according to an embodiment of the present invention in the case in which the iris photographing volume is larger than a capture volume;

FIG. 16 is a view showing an illustration of logically dividing and storing eye images of the left eye and the right eye according to an embodiment of the present invention; and

FIG. 17 is a view showing an illustration of physically dividing and storing eye images of the left eye and the right eye according to an embodiment of the present invention.

### BEST MODE

The prevent invention provides a system for acquiring an iris image for iris recognition by using a facial component distance, the system including a buffer for storing at least one face image of a subject photographed by a camera so as to acquire an image for iris recognition, a facial component distance calculation unit for calculating a facial component distance from the face image stored in the buffer, an actual distance estimation unit for estimating the actual distance between the subject and the camera from the facial component distance calculated by the facial component distance calculation unit and for determining based on the estimated distance whether the subject is in an iris photographing volume, and an iris image acquisition unit for acquiring an eye image from the face image of the subject determined to be in the iris photographing volume by the actual distance estimation unit and for measuring the quality of the acquired eye image to acquire an image for iris recognition that satisfies a reference quality level, and a method of acquiring an iris image for iris recognition by using a facial component distance, the method being performed by the system.

### MODE FOR INVENTION

A description will now be given in detail according to exemplary embodiments disclosed herein, with reference to the accompanying drawings. The construction and operation of the present invention shown in the drawings and described in the specification will be described as one or more embodiments. However, these embodiments do not limit the technical idea and the core construction and operation of the present invention. Therefore, various modifications and variations of a system and method for acquiring an iris image for iris recognition by using a facial component distance can be made by those skilled in the art without departing from the intrinsic features of an embodiment of the present invention

In addition, the terms “A,” “B,” “(a),” “(b),” etc. may be used herein to describe elements of the present invention. These terms are generally only used to distinguish one element from another, and natures, orders, and sequences of these elements are not be limited by these terms. It will be understood that when one element is referred to as being “connected with,” “included in,” or “added to” another element, the one element may be directly connected with, included in, or added to the another element, or an intervening element may be connected, included, or added between the elements.

In addition, for easy understanding, different reference numerals are used even for the same elements, in different drawings.

### Embodiments

Hereinafter, embodiments of the present invention will be described in detail.

First, facial component elements and a facial component distance in the present invention will be described.

In general, ordinary people each have facial zones, such as the left eye, the right eye, the nose, the mouth, and the jaws, as long as there is no special reason otherwise, such as an unexpected disease or accident. Such specific facial zones have been variously used for face detection, face recognition, and so forth.

The eyes (the left eye and the right eye), the eyebrows (the left eyebrow and the right eyebrow), the nose, the nostrils (the left nostril and the right nostril), the mouth, the ears, the jaws, the cheeks, the face boundary, and so forth are partially or entirely extracted and used in accordance with techniques (methods) used for such face detection or face recognition.

The eyes (the left eye and the right eye), the eyebrows (the left eyebrow and the right eyebrow), the nose, the nostrils (the left nostril and the right nostril), the mouth, the ears, the jaws, the cheeks, the face boundary, and so forth, used for face detection or face recognition as described above are generally referred to as facial elements or facial components. In the present invention, they are referred to as facial component elements, and a facial component distance is obtained from the distances between the respective facial component elements defined above. In this case, the distances between the respective facial component elements are obtained by measuring pixel distances from a face image photographed using a camera, a description of which will follow.

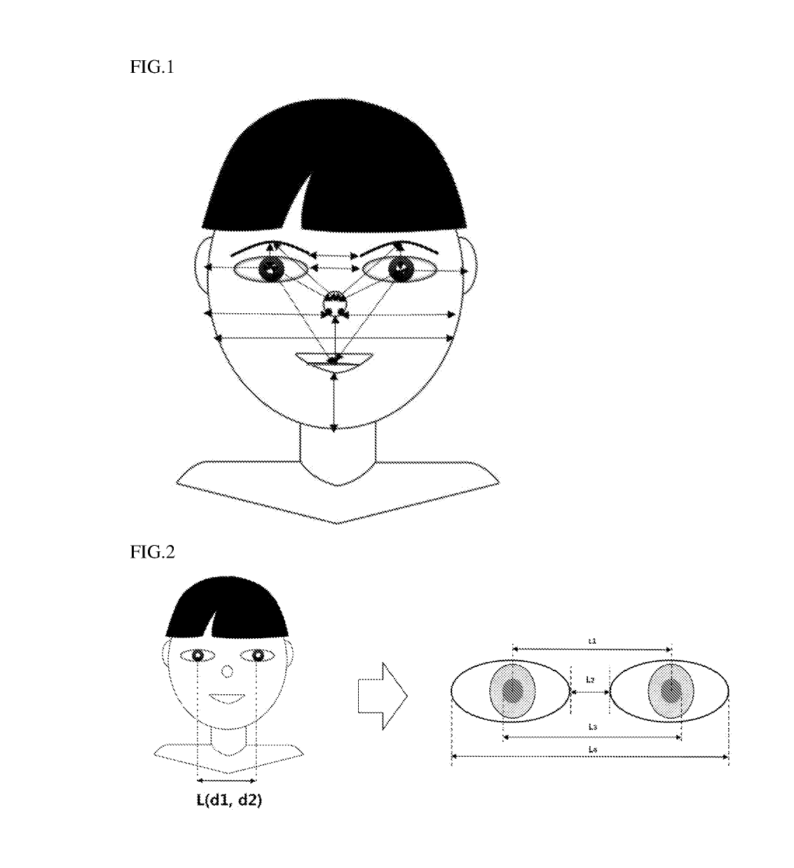

FIG. 1 is a view showing various illustrations of the distances between facial component elements according to an embodiment of the present invention.

As shown in FIG. 1, various facial component elements may be extracted in accordance with techniques (methods) used for face detection or face recognition. The distances between the respective facial component elements may differ.

For the convenience of description, assuming that a certain method used for face detection or face recognition described above is A and that k random facial component elements a1, a2, . . . , and ak are extracted by using the method A, the facial component elements will be expressed in the form of the group A={a1, a2, . . . , ak}. In addition, the distances between the facial component elements extracted by using the method A will be expressed in the form of L(ai, aj) or L(aj, ai) (ai, aj ε{a1, a2, ak}).

In the case in which m facial component elements are extracted by using a specific method B, therefore, facial component elements may be expressed in the form of B={b1, b2, . . . , bm}. In the case in which n facial component elements are extracted by using another specific method C, therefore, facial component elements may be expressed in the form of C={c1, c2, . . . , cn}.

In addition, assuming that the number of facial component elements extracted by using another specific method D is r (D={d1, d2, . . . dr}), the distances between the extracted facial component elements may be expressed as L(di, dj), and the number of distances between the existing facial component elements may be expressed as r(r−1)/2.

Consequently, one of the r(r−1)/2 distances between the facial component elements may be selected, two or more of the distances between the facial component elements may be individually used, or the distances between the facial component elements may be converted by using a multivariable regression function, so as to be used as a facial component distance.

Next, the facial component elements and the facial component distance will be described with reference to a detailed illustration.

Existence of only(T1)D={d1,d2}(r=2),L(d1,d2)

This case means that only two facial zones, such as the left eye and the right eye, the left eye and the nose, the left eye and the mouth, the right eye and the nose, the right eye and the mouth, or the nose and the mouth, are used as the facial component elements. Consequently, a single distance between the facial component elements is used. That is, the distance between the left eye and the right eye, the distance between the left eye and the nose, the distance between the left eye and the mouth, the distance between the right eye and the nose, the distance between the right eye and the mouth, or the distance between the nose and the mouth is used.

Existence of(T2)D={d1,d2,d3}(r=3),L(d1,d2),L(d1,d3),L(d2,d3)

This case means that three facial zones, such as the left eye, the right eye, and the nose, the left eye, the right eye, and the mouth, the left eye, the nose, and the mouth, or the right eye, the nose, and the mouth, are used as the facial component elements. In this case, the distances between the facial component elements are given as follows.
For the left eye, the right eye, and the nose: the distance between the left eye and the right eye, the distance between the left eye and the nose, and the distance between the right eye and the nose
For the left eye, the right eye, and the mouth: the distance between the left eye and the right eye, the distance between the left eye and the mouth, and the distance between the right eye and the mouth
For the left eye, the nose, and the mouth: the distance between the left eye and the nose, the distance between the left eye and the mouth, and the distance between the nose and the mouth
For the right eye, the nose, and the mouth: the distance between the right eye and the nose, the distance between the right eye and the mouth, and the distance between the nose and the mouth

In the case in which only one distance between the facial component elements is given as in the illustration of (T1), the distance between the facial component elements may be used as a facial component distance. On the other hand, in the case in which two or more distances between the facial component elements are given as in the illustration of (T2), one of the two or more distances between the facial component elements may be selected, the two or more distances between the facial component elements may be simultaneously used as calculation factors, or the two or more distances between the facial component elements may be calculated into a single value by using a multivariable regression function.

Next, the facial component distance constituted by the two or more distances between the facial component elements will be described in detail with reference to the illustration of (T2).

In the case in which the left eye d1, the right eye d2, and the nose d3 are selected from the illustration of (T2), for the convenience of description, three distances between the facial component elements are given. That is, L(left eye d1, right eye d2), L(left eye d1, nose d3), and L(right eye d2, nose d3) are given. Assuming that a function of calculating a facial component distance from the three measured distances between the facial component elements L(d1, d2), L(d1, d3), and L(d2, d3) is F, the facial component distance may be expressed as F(L(d1, d2), L(d1, d3), L(d2, d3)).

In the case in which one of the three measured distances between the facial component elements is to be used, the distance between the facial component elements that can be most easily measured may be selected so as to be used as the facial component distance. If the three distances between the facial component elements can be measured with the same ease, one may be randomly selected from among the distances between the facial component elements so as to be used as the facial component distance.

In the case in which the three measured distances between the facial component elements are to be individually and simultaneously used as the facial component distance, F(L(d1, d2), L(d1, d3), L(d2, d3)) may have the values of L(d1, d2), L(d1, d3), and L(d2, d3) in the form of a sequence pair, a matrix, or a vector. In the case in which the three measured distances between the facial component elements are to be converted into a single value so as to be used as the facial component distance, F(L(d1, d2), L(d1, d3), L(d2, d3)) may have a single value obtained by using a multivariable regression function.

Meanwhile, the distances between the same facial component elements described above may differ based on the positions of reference points at which the measurement is performed. The reference points are specific positions of the facial component elements necessary to measure the distances between the facial component elements. For example, the left nostril, the right nostril, the nose tip, and so forth may be used as the reference points of the nose.

FIG. 2 is a view showing an illustration of the distance between the left eye and the right eye, which may be variously measured based on the positions of reference points according to an embodiment of the present invention.

As shown in FIG. 2, even in the case in which the same left eye and the same right eye are selected, the distance between the left eye and the right eye may be variously measured based on the positions of reference points selected for distance measurement. For example, an interpupillary distance (IPD or PD) (L(d1, d2)=L1), which is the distance between the centers of the pupils of the two eyes, is mainly used in ophthalmology or eye optics. In addition, an intercanthal distance (ICD or ID) (L(d1, d2)=L2)), which is the distance between the boundaries of the two eyes adjacent to the nose, is mainly used in plastic surgery. Furthermore, the distance between the outsides of the pupils (L(d1, d2)=L3)) and a biectocanthal distance (L(d1, d2)=L4)), which is the distance between the outsides of the two eyes, are also used. That is, various distances between the left eye and the right eye may be given based on the positions of the reference points.

Next, the technical constructions of a system for acquiring an iris image for iris recognition by using the facial component distance will be described.

In the present invention, the left eye and the right eye are used as the facial component elements determined to make it easiest to understand the purport of the invention by way of example, and the interpupillary distance is used as the facial component distance by way of example. Even though the left eye and the right eye are used as the facial component elements by way of example and the interpupillary distance is used as the facial component distance by way of example, therefore, it should be understood that the same is applicable to other facial component elements and facial component distances.

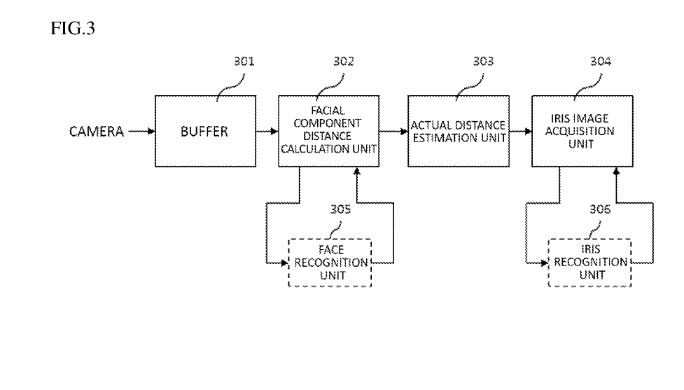

FIG. 3 is a block diagram schematically showing a system for acquiring an iris image for iris recognition by using a facial component distance according to an embodiment of the present invention.

As shown in FIG. 3, the system for acquiring the iris image for iris recognition by using the facial component distance according to the embodiment of the present invention includes a means (hereinafter, referred to as a ‘buffer’) 301 for temporarily storing an image, photographed using a camera, of a portion or the entirety of a subject, including the face of the subject, so as to acquire an image for iris recognition or an image (hereinafter, referred to as a ‘face image’ obtained by cropping only a face zone from the image of the subject photographed using the camera, a means (hereinafter, referred to as a ‘facial component distance calculation unit’) 302 for extracting facial component elements from one or more face images stored in the buffer 301 and calculating a facial component distance from the distances between the extracted facial component elements, a means (hereinafter, referred to as an ‘actual distance estimation unit’) 303 for estimating the actual distance between the subject and the camera from the facial component distance calculated by the facial component distance calculation unit 302 and determining based on the estimated distance whether the subject is in a position (hereinafter, referred to as an ‘iris photographing volume’) in which the face images are photographed under infrared lighting, and a means (hereinafter, referred to as an ‘iris image acquisition unit’) 304 for dividing images (hereinafter, referred to as ‘eye images’), obtained by cropping eye zones, including irises, from the face images of the subject determined to be in the iris photographing volume by the actual distance estimation unit 303, into an eye image of the left eye and an eye image of the right eye and storing the divided eye images and for measuring the quality of the stored eye images to acquire eye images (hereinafter, referred to as ‘images for iris recognition’) that satisfies a predetermined quality criterion (hereinafter, referred to as a ‘reference quality level’).

While the facial component elements are being extracted by the facial component distance calculation unit 302, face recognition may be performed. To this end, the system for acquiring the iris image for iris recognition by using the facial component distance according to the embodiment of the present invention may further include a face recognition unit 305, a description of which will follow.

While the images for iris recognition are being acquired by the iris image acquisition unit 304, iris recognition may be performed. To this end, the system for acquiring the iris image for iris recognition by using the facial component distance according to the embodiment of the present invention may further include an iris recognition unit 306, a description of which will follow.

Next, a method of acquiring an iris image for iris recognition by using the facial component distance will be described in detail.

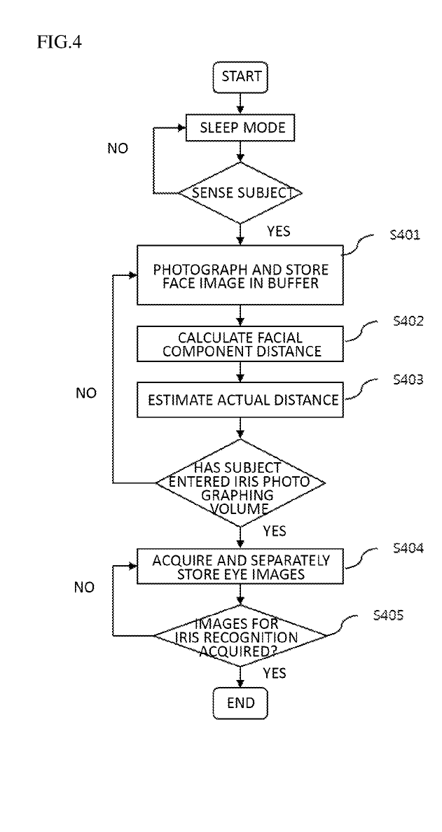

FIG. 4 is a flowchart illustrating a method of acquiring an iris image for iris recognition by using a facial component distance according to an embodiment of the present invention.

As shown in FIG. 4, the method of acquiring the iris image for iris recognition according to the embodiment of the present invention includes the following steps.

The method of acquiring the iris image for iris recognition according to the embodiment of the present invention includes a step (S401) of the camera, which is in a standby state (hereinafter, referred to as a ‘sleep mode’), sensing the subject, starting to photograph a face image of the subject, and storing the photographed face image in the buffer, a step (S402) of the facial component distance calculation unit calculating the facial component distance from the face image stored in the buffer, a step (S403) of the actual distance estimation unit estimating the actual distance between the subject and the camera based on the calculated facial component distance and determining whether the subject is in the iris photographing volume, a step (S404) of, upon determining that the subject is in the iris photographing volume, the iris image acquisition unit acquiring eye images from the face image of the subject, dividing the acquired eye images into an eye image of the left eye and an eye image of the right eye and storing the divided eye images, and a step (S405) of measuring the quality of the eye images to acquire images for iris recognition that satisfies a reference quality level.

FIG. 4 shows the sequential execution from step S401 to step S405, which, however, is merely an illustration of the technical concept of an embodiment of the present invention. Those skilled in the art will appreciate that the sequence shown in FIG. 4 may be changed, or that one or more of steps S401 to S405 may be executed simultaneously, without departing from the intrinsic features of the an embodiment of the present invention. That is, various changes and modifications are possible, and therefore the present invention is not limited to the temporal sequence shown in FIG. 4.

Next, the particular constructions of the system for acquiring the iris image for iris recognition by using the facial component distance will be described in detail.

First, the camera will be described in detail.

In the present invention, the camera is not limited to a finished product but includes a camera lens or a camera module for entrance security devices, such as door locks, into which an iris recognition technique has been introduced or into which much research on the introduction of an iris recognition technique has been conducted in recent years, other security devices, such as closed-circuit televisions (CCTVs), imaging devices, such as cameras, video players, and camcorders, and smart devices, such as smart phones, personal digital assistants (PDAs), personal computers (PCs), and laptop computers.

In general, the resolution of an image necessary for iris recognition refers to the ISO standards, which prescribe the number of pixels in the iris diameter based on a VGA resolution image. According to the ISO standards, an image having 200 or more pixels is prescribed to be a high-quality image, an image having 170 pixels is prescribed to be a normal-quality image, and an image having 120 pixels is prescribed to be a low-quality image. In the present invention, therefore, a camera having high-quality pixels capable of acquiring eye images of the left eye and the right eye while meeting the convenience of the subject is used if possible. Since different pixels may be used depending on the quality of the irises or the characteristics of other additional devices, however, it is not absolutely necessary for the camera to have high resolution. Particularly, in recent years, high-quality camera modules having a resolution of 12M or 16M pixels and a transfer rate of 30 frames or more per second have been used in digital imaging devices and smart devices. Such camera modules satisfactorily acquire images for iris recognition that satisfy a reference quality level in an iris photographing volume.

In addition, a single camera or two or more cameras may be provided in the system for acquiring the iris image for iris recognition by using the facial component distance. However, the number of cameras may be changed as needed.

In addition, cameras in conventional devices are maximally used in order to acquire a sharp iris image, whereby the addition of additional specific cameras in order to acquire a face image is minimized. However, a lighting unit may be further included in accordance with techniques (methods) used for such face detection and face recognition. For example, in a face detection and face recognition method using visible rays without using infrared rays, it is necessary to further include a lighting unit for emitting infrared rays into an iris photographing volume, a description of which will follow. On the other hand, in a face detection and face recognition method using thermal infrared rays, no additional lighting unit may be needed. Even in the case in which the lighting unit is needed, visible lighting may be used, and the visible lighting may be turned off and infrared lighting may be turned on in the iris photographing volume. Alternatively, in the case in which visible lighting is turned on in the iris photographing volume, an infrared bypass filter may be located in front of the lighting in order to transmit only infrared rays. In any case, easy implementation is possible without an increase in costs and spatial limitations.

Next, the buffer will be described in detail.

The buffer temporarily stores a single face image or a plurality of face images photographed by the camera. The buffer mainly works together with the camera and the facial component distance calculation unit.

In general, the storage space in the buffer is not large due to the characteristics of the buffer. In the present invention, therefore, only a facial component distance is calculated from a face image photographed by the camera, and then the face image is deleted, before a subject enters an iris photographing volume.

After the subject enters the iris photographing volume, the face image is stored for a predetermined time without deletion because eye images must be acquired from the face image photographed by the camera.

In the present invention, therefore, two buffers may be used to individually perform the above functions. Alternatively, a specific storage space may be added to the buffer such that the face image photographed by the camera can be stored in the specific storage space.

Next, the facial component distance calculation unit will be described in detail.

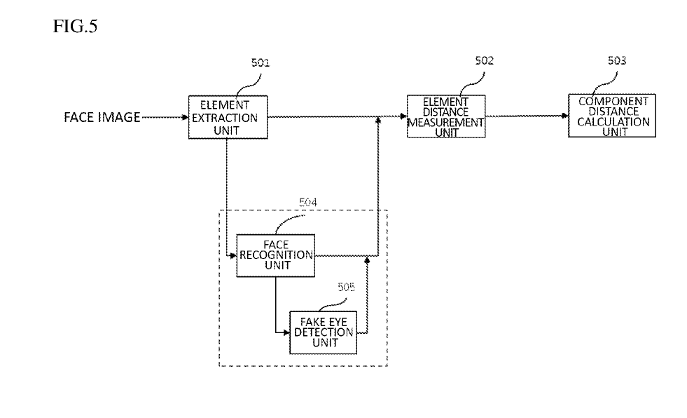

FIG. 5 is a block diagram schematically showing a facial component distance calculation unit according to an embodiment of the present invention.

As shown in FIG. 5, the facial component distance calculation unit according to the embodiment of the present invention includes a means (hereinafter, referred to as an ‘element extraction unit’) 501 for extracting facial component elements from a face image, a means (hereinafter, referred to as an ‘element distance measurement unit’) 502 for measuring the distances between the facial component elements extracted by the element extraction unit, and a means (hereinafter, referred to as a ‘component distance calculation unit’) 503 for calculating a facial component distance from the distances between the facial component elements measured by the element distance measurement unit.

A face recognition unit 504 for performing face verification and identification while the facial component elements are being extracted by the element extraction unit 501 may be added alone. Alternatively, a fake eye detection unit 505 for detecting fake eyes may be added together with the face recognition unit.

Next, a method of the facial component distance calculation unit calculating the facial component distance will be described in detail.

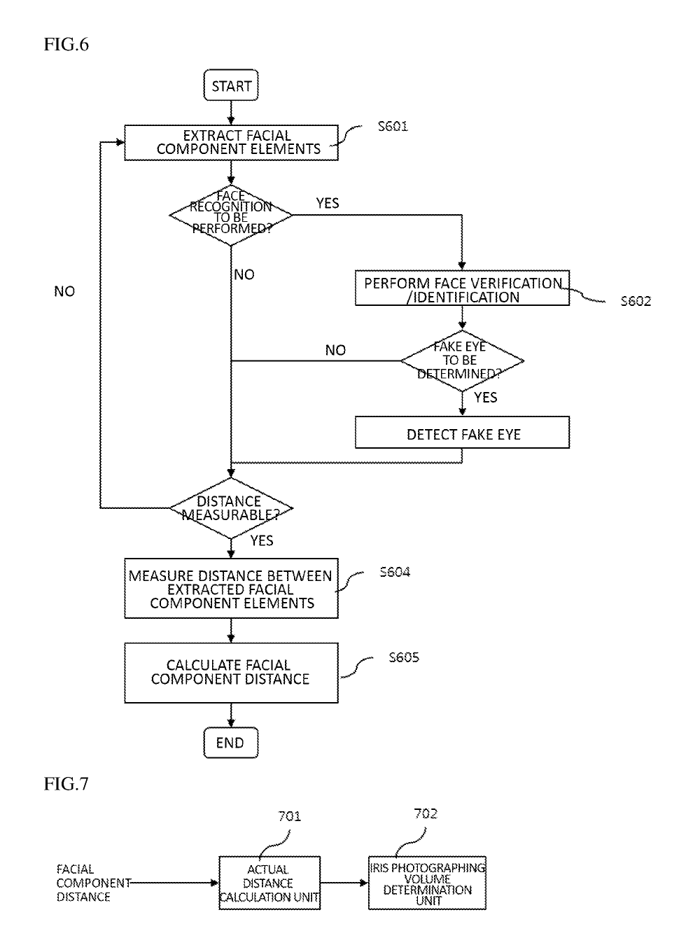

FIG. 6 is a flowchart illustrating a method of calculating a facial component distance according to an embodiment of the present invention.

As shown in FIG. 6, the method of calculating the facial component distance according to the embodiment of the present invention includes the following steps.

The method of calculating the facial component distance according to the embodiment of the present invention includes a step (S601) of the element extraction unit extracting facial component elements from the face image stored in the buffer, a step (S602) of the face recognition unit determining whether to perform face recognition using the extracted facial component elements and, if so, performing face recognition using the extracted facial component elements, a step (S603) of the fake eye detection unit determining and detecting fake eyes through the performed face recognition, a step (S604) of the element distance measurement unit determining whether there are facial component elements the distances between which can be measured, among the extracted facial component elements, and, if so, measuring the distances between the facial component elements, and a step (S605) of the component distance calculation unit calculating the facial component distance from the measured distances between the facial component elements.

FIG. 6 shows the sequential execution from step S601 to step S605, which, however, is merely an illustration of the technical concept of an embodiment of the present invention. Those skilled in the art will appreciate that the sequence shown in FIG. 6 may be changed, or that one or more of steps S601 to S605 may be executed simultaneously, without departing from the intrinsic features of the embodiment of the present invention. That is, various changes and modifications are possible, and therefore the present invention is not limited to the temporal sequence shown in FIG. 6.

Next, the element extraction unit will be described in detail.

In the present invention, the element extraction unit extracts facial component elements using well-known techniques used for face detection and face recognition in a face verification system.

Face detection is a process performed before face recognition. Face detection definitely affects face recognition efficiency. Up to now, a color-based detection method mainly using a color component of an HSI color model, a face detection method compositely using color information and movement information, and a facial zone detection method using color information and edge information of an image have been used to perform face detection.

A geometric feature-based method, a template-based method, a model-based method, and a method using thermal infrared rays or a three-dimensional face image have also been used to perform face recognition.

OpenCV or the like has been widely used all over the world as an open-source method used for face detection and face recognition.

In the present invention, therefore, any one selected from the techniques described above may be used as long as facial component elements can be easily extracted from a face image using the selected technique. The conventional techniques for face detection and face recognition are well-known, and therefore a detailed description thereof will be omitted.

The element extraction unit extracts all or some of the eyes (the left eye and the right eye), the eyebrows (the left eyebrow and the right eyebrow), the nose, the nostrils (the left nostril and the right nostril), the mouth, the ears, the jaws, the cheeks, the face boundary, and so forth in accordance with the conventional techniques used for face detection or face recognition. Principally, the element extraction unit extracts the eyes (the left eye and the right eye).

Assuming that a certain method used by the element extraction unit for face detection or face recognition described above is A and that k random facial component elements a1, a2, . . . , and ak are extracted by using the method A, the facial component elements will be expressed in the form of the group A={a1, a2, . . . ak}. In addition, the distances between the facial component elements extracted by using the method A will be expressed in the form of L(ai, aj) or L(aj, ai) (A={a1, a2, . . . ak}).

In the case in which m facial component elements are extracted by using a specific method B, therefore, facial component elements may be expressed in the form of B={b1, b2, . . . , bm}. In the case in which n facial component elements are extracted by using another specific method C, therefore, facial component elements may be expressed in the form of C={c1, c2, . . . cn}.

In addition, assuming that the number of facial component elements extracted by using another specific method D is r (D={d1, d2, . . . , dr}), the distances between the extracted facial component elements may be expressed as L(di, dj), and the number of distances between the existing facial component elements may be expressed as r(r−1)/2.

The detailed technical constructions of the above are the same as those described in connection with the facial component elements and the facial component distance, and therefore a detailed description thereof will be omitted.

Next, the element distance measurement unit will be described in detail

The element distance measurement unit measures the distances between the facial component elements extracted by the element extraction unit and uses some or all of the measured distances between the facial component elements. The distances between the facial component elements are obtained by measuring the pixel distances between the facial component elements in the face image stored in the buffer.

The distances between the facial component elements may be variously measured based on the positions of reference points at which the measurement is performed. For example, even in the case in which the same left eyes and the same right eyes are selected, the distance between the left eye and the right eye may be variously measured based on the positions of reference points selected for distance measurement. For example, an interpupillary distance (IPD or PD) (L(d1, d2)=L1), which is the distance between the centers of the pupils of the two eyes, is mainly used in ophthalmology or eye optics. In addition, an intercanthal distance (ICD or ID) (L(d1, d2)=L2)), which is the distance between the boundaries of the two eyes adjacent to the nose, is mainly used in plastic surgery. Furthermore, a distance between the outsides of the pupils (L(d1, d2)=L3)) and a biectocanthal distance (L(d1, d2)=L4)), which is the distance between the outsides of the two eyes, are also used. That is, various distances between the left eye and the right eye may be given based on the positions of the reference points.

Next, the facial component distance will be described with reference to a detailed illustration.

Existence of only(T1)D={d1,d2}(r=2),L(d1,d2)

This case means that only two facial zones, such as the left eye and the right eye, the left eye and the nose, the left eye and the mouth, the right eye and the nose, the right eye and the mouth, or the nose and the mouth, are used as the facial component elements. Consequently, a single distance between the facial component elements is used. That is, the distance between the left eye and the right eye, the distance between the left eye and the nose, the distance between the left eye and the mouth, the distance between the right eye and the nose, the distance between the right eye and the mouth, or the distance between the nose and the mouth is used.

Existence of(T2)D={d1,d2,d3}(r=3),L(d1,d2),L(d1,d3),L(d2,d3)

This case means that three facial zones, such as the left eye, the right eye, and the nose, the left eye, the right eye, and the mouth, the left eye, the nose, and the mouth, or the right eye, the nose, and the mouth, are used as the facial component elements. In this case, the distances between the facial component elements are given as follows.
For the left eye, the right eye, and the nose: the distance between the left eye and the right eye, the distance between the left eye and the nose, and the distance between the right eye and the nose
For the left eye, the right eye, and the mouth: the distance between the left eye and the right eye, the distance between the left eye and the mouth, and the distance between the right eye and the mouth
For the left eye, the nose, and the mouth: the distance between the left eye and the nose, the distance between the left eye and the mouth, and the distance between the nose and the mouth
For the right eye, the nose, and the mouth: the distance between the right eye and the nose, the distance between the right eye and the mouth, and the distance between the nose and the mouth

The detailed technical constructions of the above are the same as those described in connection with the facial component elements and the facial component distance, and therefore a detailed description thereof will be omitted.

Next, the component distance calculation unit will be described in detail.

One of the distances between the facial component elements measured by the element distance measurement unit may be selected, or two or more of the distances between the facial component elements may be selected, so as to be used as the facial component distance. In the case in which there are two or more distances between the facial component elements, the two or more distances between the facial component elements may be used simultaneously, or may be converted into a single distance between the facial component elements.

First, in the case in which there is a single distance between the facial component elements, the single distance between the facial component elements is used as the facial component distance. Even in the case in which there are two or more distances between the facial component elements, only one of the distances between the facial component elements may be selected so as to be used as the facial component distance.

Second, in the case in which there are two or more distances between the facial component elements and in which two or more distances between the facial component elements are selected, the two or more of the distances between the facial component elements may be simultaneously used as calculation factors, or the distances between the facial component elements may be converted by using a multivariable regression function, so as to be used as the facial component distance.

Next, the facial component distance constituted by the two or more distances between the facial component elements will be described in detail with reference to the illustration of (T2).

In the case in which the left eye d1, the right eye d2, and the nose d3 are selected from the illustration of (T2), for the convenience of description, three distances between the facial component elements are given. That is, L(left eye d1, right eye d2), L(left eye d1, nose d3), and L(right eye d2, nose d3) are given. Assuming that a function of calculating the facial component distance from the three measured distances between the facial component elements L(d1, d2), L(d1, d3), and L(d2, d3) is F, the facial component distance may be expressed as F(L(d1, d2), L(d1, d3), L(d2, d3)).

In the case in which one of the three measured distances between the facial component elements is to be used, the distance between the facial component elements that can be most easily measured may be selected so as to be used as the facial component distance. If the three distances between the facial component elements can be measured with the same ease, one may be randomly selected from among the distances between the facial component elements so as to be used as the facial component distance.

In the case in which the three measured distances between the facial component elements are to be individually and simultaneously used as the facial component distances, F(L(d1, d2), L(d1, d3), L(d2, d3)) may have the values of L(d1, d2), L(d1, d3), and L(d2, d3) in the form of a sequence pair, a matrix, or a vector. In the case in which the three measured distances between the facial component elements are to be converted into a single value so as to be used as the facial component distance, F(L(d1, d2), L(d1, d3), L(d2, d3)) may have a single value converted by using a multivariable regression function.

The detailed technical constructions of the above are the same as those described in connection with the facial component elements and the facial component distance, and therefore a detailed description thereof will be omitted.

Next, the face recognition unit will be described in detail.

In general, the terms ‘verification’, ‘identification,’ and ‘recognition’ are used in the recognition field. The term ‘verification’ is used for one-to-one (1:1) matching, the term ‘identification’ or ‘searching’ is used for one-to-many (1:N) matching, and the term ‘recognition’ includes the meanings of ‘verification’ and ‘identification.’

The face recognition unit performs face recognition with respect to the face image of the subject stored in the buffer by using the face detection and face recognition technique used by the element extraction unit described above. In the present invention, even if the result of the face recognition is not precise, images for iris recognition may be acquired by the iris image acquisition unit, a description of which will follow, and the result of iris recognition performed by the iris recognition unit may be combined with the result of the face recognition, whereby face recognition accuracy may be improved.

In addition, face recognition may be easily performed while the facial component elements are extracted by using a solution, such as OpenCV, which has been widely used all over the world for face detection and face recognition.

Next, the fake eye detection unit will be described in detail.

In general, various kinds of research have been conducted to prevent fake images from being acquired in the face recognition field as well as the iris recognition field. For example, a method of detecting fake faces by using Fourier spectrum analysis, a method of detecting fake faces by using eye movement, a method of detecting fake faces by using eye flickering, and so forth have been widely used in the face recognition field.

In recent years, an eye-tracking technique of sensing the movement of the pupils to track the positions of the eyes has been rapidly developed. In particular, a video analysis technique of analyzing camera images in real time to detect the movement of the pupils, which is one of various conventional techniques, may be used to determine whether image for iris recognition are real or fake.

Consequently, the fake eye detection unit may use any one of the fake image detection technique and the eye-tracking technique in the conventional face recognition field described above as long as fake images are prevented from being acquired as images for iris recognition (liveness detection). In addition, the fake eye detection unit may be added to the face recognition unit.

Next, the actual distance estimation unit will be described in detail.

FIG. 7 is a block diagram schematically showing an actual distance estimation unit according to an embodiment of the present invention.

As shown in FIG. 7, the actual distance estimation unit according to the embodiment of the present invention includes a means (hereinafter, referred to as an ‘actual distance calculation unit’) 701 for calculating and estimating the actual distance between a subject and a camera using a function describing the relationship between the facial component distance and the actual distance between the subject and the camera acquired through prior experimentation and stored in a memory or a database of a computer or a terminal and a means (hereinafter, referred to as an ‘iris photographing volume determination unit’) 702 for determining, from the actual distance between the subject and the camera estimated by the actual distance calculation unit, whether the subject is in the iris photographing volume.

Next, the actual distance calculation unit will be described in detail.

Before describing the actual distance calculation unit, the principle of obtaining the function describing the relationship between the facial component distance and the actual distance between the subject and the camera will be described.

A pinhole camera model is used as a simple and ideal explanation of the relationship between the facial component distance and the actual distance between the subject and the camera, which is generally known.

FIG. 8 is a view showing an illustration of the principle of a pinhole camera model indicating the relationship between the facial component distance and the actual distance according to an embodiment of the present invention. As shown in FIG. 8, assuming that the actual size of an object and the size of the object in an image are A and a, respectively, the focal distance is f, and the distance between the camera and the object is Z, the following relationship may be derived through a proportional expression of a triangle (Equation 1).

a=f*(A/Z) (Equation 1).

Equation 1 may be converted into a function having Z as an independent variable in order to derive the following equation (Equation 2).

Z=f*(A/a) (Equation 2)

If the facial component distance is obtained from the face image corresponding to the size a of the object in the image, the actual distance between the subject and the camera corresponding to the distance Z between the camera and the object may be obtained using Equation 2.

In reality, however, images are photographed in a three-dimensional space, rather than the two-dimensional plane shown in FIG. 8, and it is very difficult for the optical axis to pass through the center of a sensor. In addition, it is not possible to apply the principle of the pinhole camera model without modification for various reasons, such as the characteristics of the camera (the focus of a lens, a composite lens, an angle of view, and so forth), difficulty in alignment of the lens with a pinhole, or the characteristics (age and so forth) of the subject.

In the present invention, therefore, the subject may move in the state in which the camera is stationary or the camera may move in the state in which the subject is stationary so as to measure the actual distance between the subject and the camera and the facial component distance at various positions, and a function describing the relationship between two variables is obtained from the measured values by using a statistical means (mainly, regression analysis).

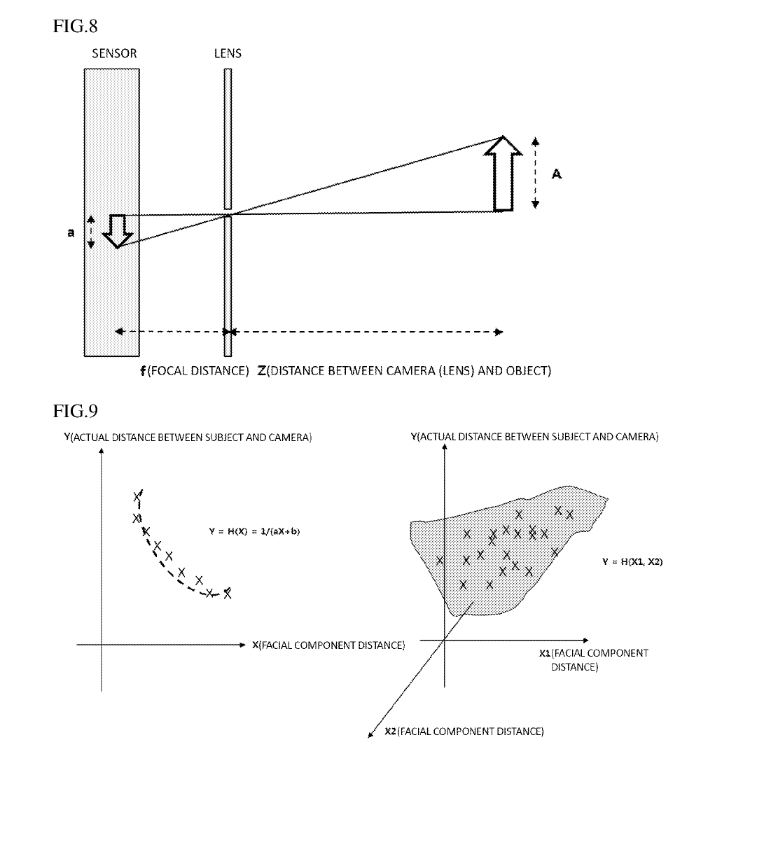

FIG. 9 is a view showing an illustration of the principle of obtaining a function describing the relationship between a facial component distance and an actual distance by using a statistical means (mainly, regression analysis) according to an embodiment of the present invention.

As shown in FIG. 9, the actual distance between the subject and the camera (variable Y, that is, a dependent variable) and the facial component distance (variable X, that is, an independent variable) are measured and marked on the coordinate axes. If there is a single facial component distance, the facial component distance may be expressed as Y=H(X). If there are two or more facial component distances, the facial component distances may be expressed as Y=H(X1, X2, . . . , Xn). A function representing the points marked on the coordinate axes is obtained from the points by using a statistical means (mainly, regression analysis). In two dimensions, the function generally has a hyperbola of Y=1/(aX+b). Alternatively, the function may be expressed as various curves, such as a parabola. In three dimensions, in which two facial component distances are given, the function may be expressed as various cubic curves. In the case in which n facial component distances, denoted by X1, X2, . . . , and Xn, are given, the actual distance Y between the subject and the camera may be obtained by using a multivariable regression function, such as an H function, expressed as Y=H(X1, X2, . . . , Xn).

In general, a single function is commonly used for all users. In the case in which calibration is required in consideration of the characteristics of the camera and the sensor or the age of the subject (a child, an old person, or the like), however, functions that differ for users are used to estimate the actual distance after calibration.

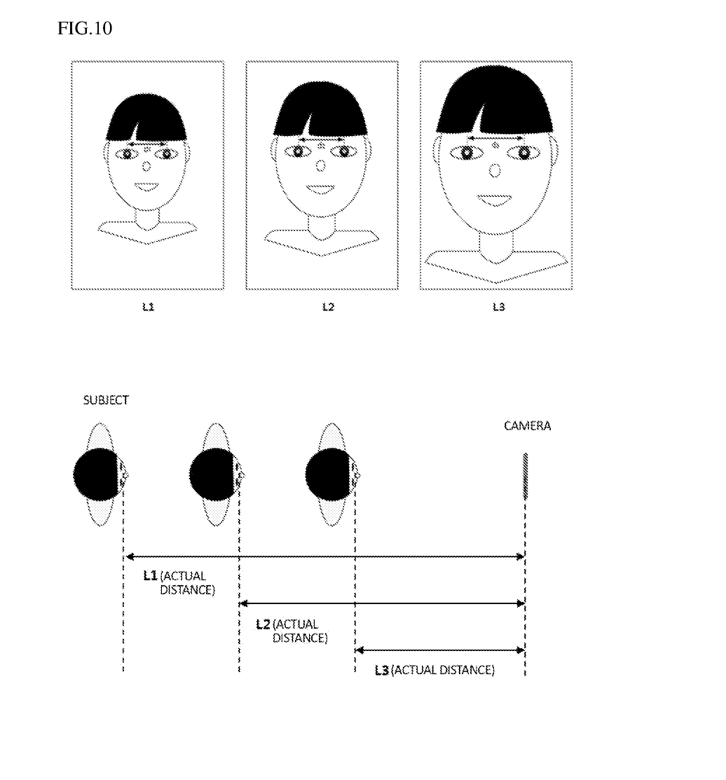

FIG. 10 is a view showing an easy-to-grasp illustration of the relationship between a facial component distance and the actual distance between a subject and a camera estimated by using an interpupillary distance as a facial component distance according to an embodiment of the present invention.

As shown in FIG. 10, the actual distance calculation unit substitutes interpupillary distances d1, d2, and d3 into the function obtained as described above to calculate and estimate the actual distances L1, L2, and L3 between the subject and the camera.

Next, the iris photographing volume determination unit will be described in detail.

In general, entrance security devices, such as door locks, into which an iris recognition technique has been introduced or into which much research on the introduction of an iris recognition technique has been conducted in recent years, other security devices, such as CCTVs, imaging devices, such as cameras, video players, and camcorders, and smart devices, such as smart phones, PDAs, PCs, and laptop computers, each have a position (hereinafter, referred to as a ‘capture volume’) in which a sharp image of the subject can be photographed. Consequently, eye images acquired from a face image photographed when the subject enters the capture volume may have high quality. However, the iris photographing volume may not be exactly the same as the capture volume. That is, a specific criterion may be selected such that the iris photographing volume is set to be larger than the capture volume.

Next, a method of setting the iris photographing volume in the case in which the iris photographing volume is different from the capture volume will be described.

(S1) Setting of the iris photographing volume on a distance basis

In general, a capture volume is preset for each device. A predetermined margin distance may be allocated before entry into the capture volume or after exit from the capture volume so as to set an iris photographing volume. At the time of entry into the iris photographing volume, therefore, the buffer starts to store a face image from the camera. At the time of exit from the iris photographing volume, the storing operation is finished.

(S2) Setting of the iris photographing volume on a time basis

A predetermined margin time may be allocated before entry into the capture volume or after exit from the capture volume so as to set an iris photographing volume. At the time of entry into the iris photographing volume, therefore, the buffer starts to store a face image from the camera. At the time of exit from the iris photographing volume, the storing operation is finished.

The margin distance and the margin time may be set based on the minimum number of face images necessary to acquire images for iris recognition, the number of eye images acquired from the face images, or the number of eye images that satisfy a reference quality level.

The capture volume and the iris photographing volume will be mentioned in detail when the eye image extraction unit will be described hereinafter. In the present invention, the capture volume may also be referred to as the iris photographing volume for the convenience of description except for the case in which the capture volume and the iris photographing volume are to be specifically distinguished from each other.

In addition, a means (hereinafter, referred to as an ‘intuitive image guide unit’) for providing a made-up image guide (hereinafter, referred to as an ‘intuitive image guide’) to guide the subject so as to enter the iris photographing volume or a means (hereinafter, referred to as an ‘actuator controller’) for controlling an actuator of the camera may be added to the iris photographing volume determination unit.

The intuitive image guide unit is mainly used in the case in which the camera is stationary and the subject moves slowly back and forth such that the subject enters the iris photographing volume or in the case in which a mobile device, such as a smart phone, is moved to guide the subject so as to enter the iris photographing volume. The intuitive image guide based on the size, sharpness, or color of the face image may be used such that the subject can recognize the intuitive image guide.

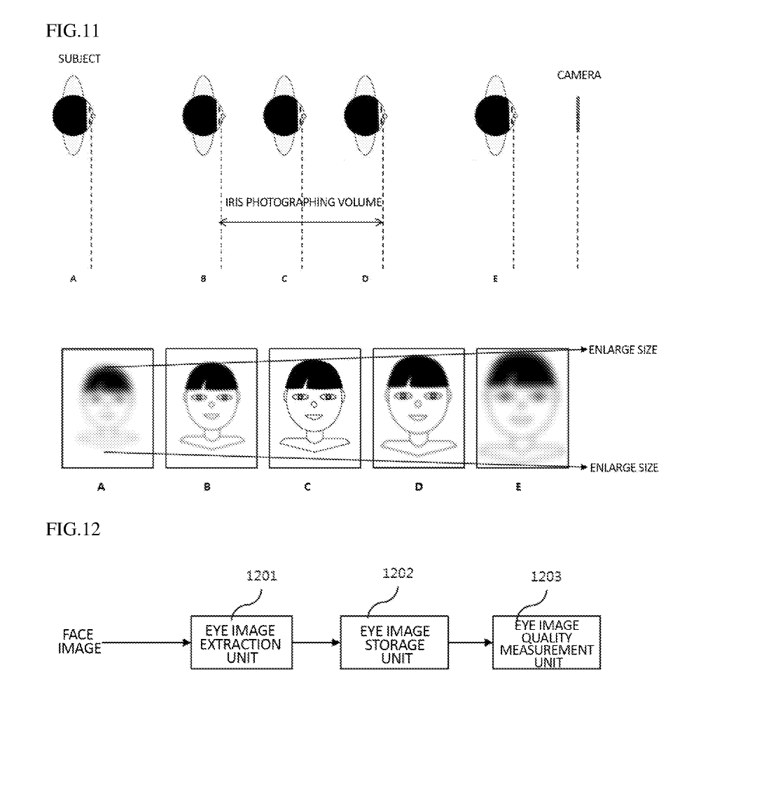

FIG. 11 is a view showing an illustration, using the screen of a smart phone, of a method of a guide unit according to an embodiment of the present invention informing a subject that the subject has approached an iris photographing volume by using an intuitive image guide.

As shown in FIG. 11, an intuitive image guide is provided on the screen of the smart phone while the actual distance between the camera mounted in the smart phone and the subject is changed, and the subject may intuitively confirm the intuitive image guide through the screen of the smart phone.

More specifically, as the subject moves from position A to position E, the subject approaches the camera. As the distance between the camera and the subject is decreased, the size of the face image of the subject may be increased. As the distance between the camera and the subject is increased, the size of the face image of the subject may be decreased. In this way, the subject may intuitively confirm information about perspective and distance.

In addition, in order to inform the subject that the subject is in the iris photographing volume, a blurry image may be provided when the subject is not in the iris photographing volume, and a sharp image may be transmitted such that the subject can intuitively confirm that the subject is in the iris photographing volume when the subject is in the iris photographing volume, thereby maximizing the convenience of the subject.

In addition, an image having white or black as a background color may be provided when the subject is not in the iris photographing volume such that the subject cannot be recognized, and the photographed image of the subject may be transmitted without change of color such that the subject can intuitively confirm that the subject is in the iris photographing volume when the subject is in the iris photographing volume, thereby maximizing the convenience of the subject.

The actuator controller is mainly used in the case in which the subject is stationary, and the entirety of the camera, the camera lens of the camera, or the camera sensor of the camera automatically moves back and forth so as to guide the subject to enter the iris photographing volume. The actuator controller guides the subject to minimize his/her motion and to gaze with his/her eyes or open his/her eyes wide.

In the present invention, a means for generating an auditory signal, such as sound or voice, a means, such as a light emitting diode (LED) or a flash, for generating a visual signal, or a means for generating vibrations may be added to the intuitive image guide used by the intuitive image guide unit. Even if there is not a display, such as a mirror or a liquid crystal display (LCD), capable of transmitting an intuitive image guide, unlike a smart phone, the above-described means may be easily added without an increase in costs and spatial limitations.

Next, the iris image acquisition unit will be described in detail.

FIG. 12 is a block diagram schematically showing an iris image acquisition unit according to an embodiment of the present invention.

As shown in FIG. 12, the iris image acquisition unit according to the embodiment of the present invention includes a means (hereinafter, referred to as an ‘eye image extraction unit’) 1201 for extracting eye images of the left eye and the right eye from the face image photographed in the iris photographing volume and stored in the buffer, a means (hereinafter, referred to as an ‘eye image storage unit’) 1202 for dividing the eye images extracted by the eye image extraction unit into an eye image of the left eye and an eye image of the right eye and storing the divided eye images, and a means (hereinafter, referred to as an ‘eye image quality measurement unit’) 1203 for measuring the quality of the eye images of the left eye and the right eye stored in the eye image storage unit, determining whether the measured quality of the eye images satisfies a reference quality level, and, if so, acquiring eye images the quality of which satisfies the reference quality level as images for iris recognition.

Next, a method of acquiring images for iris recognition from the face image photographed in the iris photographing volume will be described in detail.

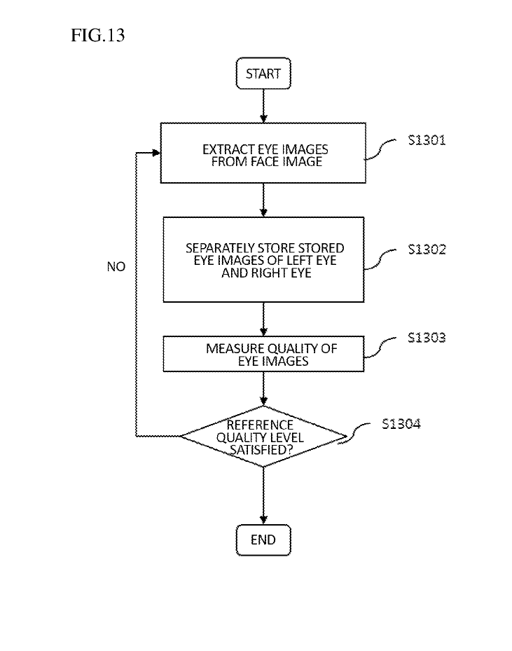

FIG. 13 is a flowchart illustrating a method of acquiring images for iris recognition according to an embodiment of the present invention.

As shown in FIG. 13, the method of acquiring the images for iris recognition according to the embodiment of the present invention includes the following steps.

The method of acquiring the images for iris recognition according to the embodiment of the present invention includes a step (1301) of the eye image extraction unit extracting eye images of the left eye and the right eye from the face image photographed in the iris photographing volume and stored in the buffer, a step (1302) of dividing the extracted eye images into an eye image of the left eye and an eye image of the right eye and storing the divided eye images in the eye image storage unit, a step (1303) of the eye image quality measurement unit measuring the quality of the stored eye images of the left eye and the right eye, and a step (1304) of the eye image quality measurement unit determining whether the measured quality of the eye images satisfies a reference quality level and, if so, acquiring the eye images the quality of which satisfies the reference quality level as images for iris recognition.

FIG. 13 shows the sequential execution from step S1301 to step S1304, which, however, is merely an illustration of the technical concept of an embodiment of the present invention. Those skilled in the art will appreciate that the sequence shown in FIG. 13 may be changed, or that one or more of steps S1301 to S1304 may be executed simultaneously, without departing from the intrinsic features of the an embodiment of the present invention. That is, various changes and modifications are possible, and therefore the present invention is not limited to the temporal sequence shown in FIG. 13.

Next, the eye image extraction unit will be described in detail.

Before describing the eye image extraction unit, the principle of extracting eye images from the face image photographed in the iris photographing volume will be described. In particular, the principle of extracting eye images from the face image in the case in which the iris photographing volume is equal to the capture volume and in the case in which the iris photographing volume is larger than the capture volume will be described.

In a face detection and face recognition method using visible rays but not infrared rays, it is necessary to further include a lighting unit for emitting infrared rays into the iris photographing volume, a description of which will follow. On the other hand, in a face detection and face recognition method using thermal infrared rays, no additional lighting unit may be needed. The light source may be adjusted as follows. First, visible lighting may be used, and the visible lighting may be turned off and infrared lighting may be turned on in the iris photographing volume. Second, visible lighting may be used, and an infrared bypass filter may be attached to the visible lighting such that only infrared rays can be used as the light source in the iris photographing volume.

(R1) Case in which iris photographing volume is equal to capture volume

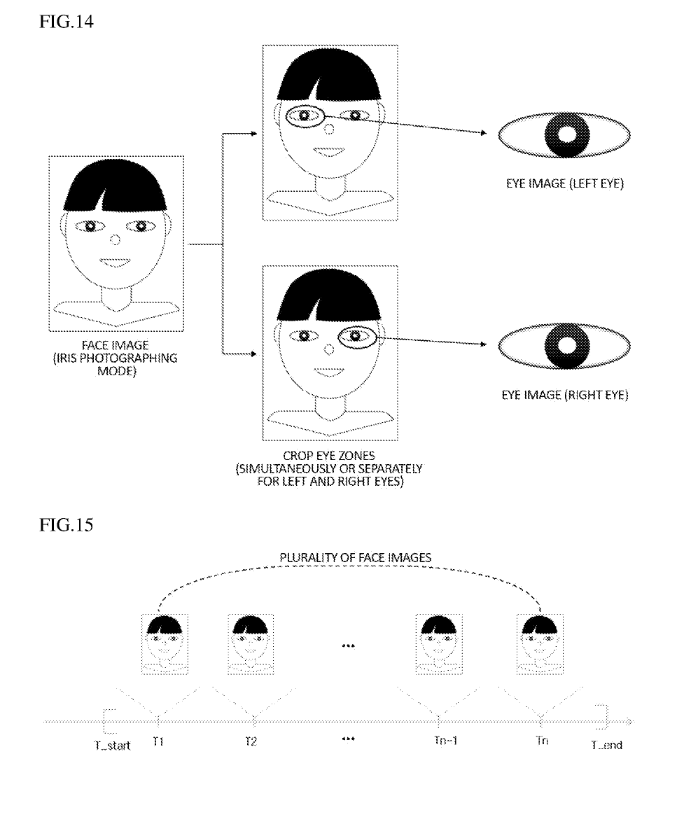

FIG. 14 is a view showing an illustration of the principle of extracting eye images from face images photographed in an iris photographing volume according to an embodiment of the present invention.

As shown in FIG. 14, a plurality of face images of a subject photographed when the subject enters an iris photographing volume (=a capture volume) is acquired. Eye zones, including portions or the entireties of the eyes necessarily including iris zones, are found from the acquired face images of the subject. The method used at this time is identical to that described in connection with the element extraction unit of the facial component distance calculation unit, and therefore a detailed description thereof will be omitted. After the eye zones including irises are found, the eye zones are cropped from the face images. At this time, cropping is performed in a predetermined shape, such as a quadrangular shape, a circular shape, or an oval shape. The eye zones of the left eye and the right eye may be simultaneously or separately cropped.

(R2) Case in which iris photographing volume is larger than capture volume

This case is the case in which the iris photographing volume is not equal to the capture volume and in which a predetermined time or distance is added before entry into the capture volume or after exit from the capture volume. A plurality of face images of a subject photographed when the subject enters an iris photographing volume is automatically acquired. Unlike the case of (R1), however, eye zones including irises are found from a plurality of face images of a subject photographed when the subject enters the capture volume, rather than the iris photographing volume, and then the eye zones are cropped from the face images.

FIG. 15 is a view showing an illustration of the principle of extracting eye images from face images photographed in an iris photographing volume according to an embodiment of the present invention in the case in which the iris photographing volume is larger than a capture volume;

As shown in FIG. 15, assuming that a photographing start time after entry into the iris photographing volume is T_start and a photographing end time is T_end, n face images are automatically acquired from T1 to Tn at a predetermined number per second therebetween. However, assuming that a photographing start time after entry into the capture volume is T1 and a photographing end time is Tn, (n−2) face images are automatically acquired from T2 to Tn−1. Consequently, no eye images are acquired from the face images between T1 and Tn, but eye images are acquired from the (n−2) face images between T2 and Tn−1.

Conventionally, processing is continuously performed in order to acquire images for iris recognition. For this reason, it is not possible to continuously acquire images for iris recognition if entrance security devices, such as door locks, other security devices, such as CCTVs, imaging devices, such as cameras, video players, and camcorders, and smart devices, such as smart phones, PDAs, PCs, and laptop computers, do not have sufficient resources and battery capacity. In particular, small-sized devices, such as smart phones, have limited resources and battery capacities, with the result that it is not possible to acquire images for iris recognition for a long time. In the present invention, therefore, eye images are acquired from a face image acquired in the capture volume in order to mitigate limitations in resources and battery capacity.

Next, the eye image storage unit will be described in detail.

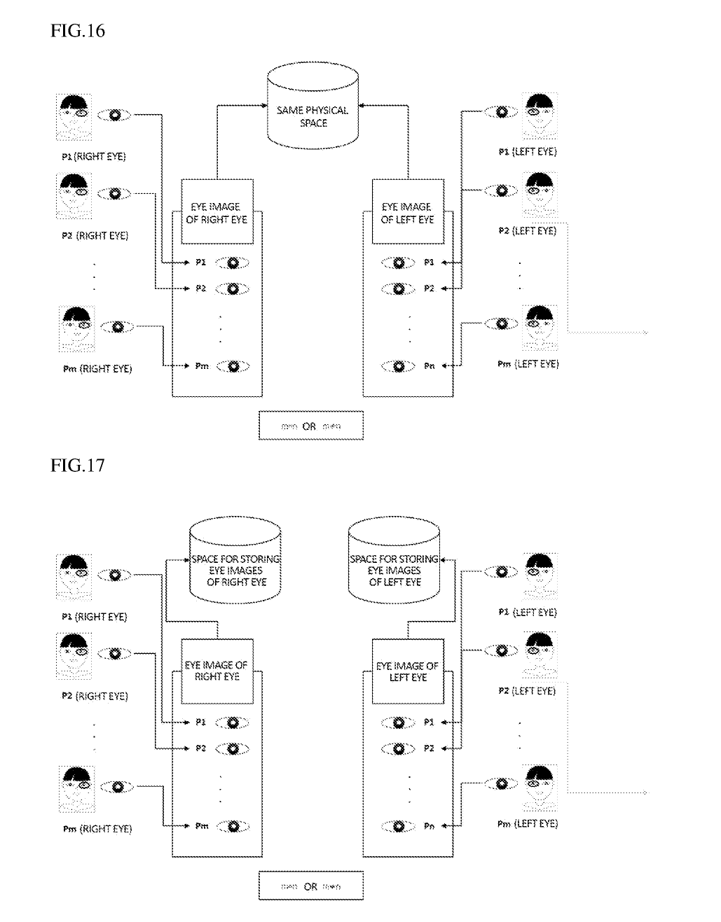

FIG. 16 is a view showing an illustration of logically dividing and storing eye images of the left eye and the right eye according to an embodiment of the present invention.

As shown in FIG. 16, a single physical space for storing eye images is logically divided into a space for storing eye images of the left eye and a space for storing eye images of the right eye such that the eye images of the left eye and the eye images of the right eye can be separately stored in different logical spaces.

FIG. 17 is a view showing an illustration of physically dividing and storing eye images of the left eye and the right eye according to an embodiment of the present invention.

As shown in FIG. 17, a physical space for storing eye images of the left eye and a physical space for storing eye images of the right eye are separately provided such that the eye images of the left eye and the eye images of the right eye can be separately stored in different physical spaces.

An eye image of the left eye and an eye image of the right eye may have different quality levels even though the eye images are acquired from the same face image. For example, in the case in which the left eye is open but the right eye is closed, the eye image of the left eye and the eye image of the right eye may have different quality levels even though the eye image of the left eye and the eye image of the right eye are acquired from the same face image. As shown in FIGS. 16 and 17, therefore, the number of eye images acquired from the same number (m) of face images may differ (the number of eye images of the right eye may be m, whereas the number of eye images of the left eye may be n, or vice versa, or the number of eye images of the right eye may be equal to the number of eye images of the left eye). In consideration of the above-mentioned characteristics, the eye image storage unit separately stores the eye images of the left eye and the eye images of the right eye.

Next, the eye image quality measurement unit will be described in detail.

The eye image quality measurement unit measures the quality (hereinafter, referred to as an ‘item quality level’) of a plurality of eye images of the left eye and the right eye separately stored in the eye image storage unit based on measurement items (hereinafter, referred to as ‘characteristic items’). The item quality level is expressed as numerical values.

Next, the characteristic items will be described in detail. The characteristic items include items A1 to A3, which are necessary to select general images having no relations with the iris characteristics, and items A4 to A12, which are related to the iris characteristics.

The first characteristic items include sharpness (A1), a contrast ratio (A2), and a noise level (A3). The second characteristic items include the capture range of an iris zone (A4), a light reflection degree (A5), the position of an iris (A6), the sharpness of an iris (A7), the contrast ratio of an iris (A8), the noise level of an iris (A9), the sharpness of an iris boundary (A10), the contrast ratio of an iris boundary (A11), and the noise level of an iris boundary (A12). In addition, various other measurement items may be added, or the above-specified items may be omitted based on the iris characteristics. That is, the above-specified items are merely an illustration (see Table 1). Table 1 shows the characteristic items of the iris.

TABLE 1

| | Item quality |
|---|---|
| Characteristic item | level |
| (A1) Sharpness | a1 |
| (A2) Contrast ratio | a2 |
| (A3) Noise level | a3 |
| (A4) Capture range of iris zone | a4 |
| (A5) Light reflection degree | a5 |
| (A6) Position of iris | a6 |
| (A7) Sharpness of iris | a7 |
| (A8) Contrast ratio of iris | a8 |
| (A9) Noise level of iris | a9 |
| (A10) Sharpness of iris boundary | a10 |
| (A11) Contrast ratio of iris boundary | a11 |
| (A12) Noise level of iris boundary | a12 |

The item quality level measured by the eye image quality measurement unit is compared with the reference quality level to select eye images that satisfies the reference quality level as eye images for iris recognition. In the case in which there is no eye image of the left eye that satisfies the reference quality level or in the case in which there is no eye image of the right eye that satisfies the reference quality level, all of the eye images of the left or right eye are discarded, and then the acquisition of new eye images is requested. In the case in which there are neither eye image of the left eye that satisfies the reference quality level nor eye image of the right eye that satisfies the reference quality level, all of the eye images of the left and right eyes are discarded, and then the acquisition of new eye images is requested. Consequently, the acquisition of new eye images is repeatedly requested until a pair of images for iris recognition including eye images of the left eye and the right eye that satisfies the reference quality level is acquired.

In the case in which there is a plurality of eye images of the left eye and the right eye that satisfies the reference quality level, the average value (hereinafter, referred to as a ‘total quality level’) of the item quality levels of the eye images is calculated through evaluation, and then one of the eye images having the highest total quality level is selected. The eye image evaluation process may be performed in real time during the acquisition of the images for iris recognition. In the present invention, the weighted addition of the item quality levels is used as one of the representative methods of evaluating the total quality level.

Assuming that the numerical value of the sharpness of an image is a1, the weight of which is w1, the numerical value of the contrast ratio of an image is a2, the weight of which is w2, the numerical value of the noise level of an image is a3, the weight of which is w3, the numerical value of the capture range of an iris zone is a4, the weight of which is w4, the numerical value of a light reflection degree is a5, the weight of which is w5, the numerical value of the position of an iris is a6, the weight of which is w6, the numerical value of the sharpness of an iris is a7, the weight of which is w7, the numerical value of the contrast ratio of an iris is a8, the weight of which is w8, the numerical value of the noise level of an iris is a9, the weight of which is w9, the numerical value of the sharpness of an iris boundary is a10, the weight of which is w10, the numerical value of the contrast ratio of an iris boundary is a11, the weight of which is w11, and the numerical value of the noise level of an iris boundary is a12, the weight of which is w12, the total quality level is a value obtained by adding the product of w1 and a1, the product of w2 and a2, the product of w3 and a3, the product of w4 and a4, the product of w5 and a5, the product of w6 and a6, the product of w7 and a7, the product of w8 and a8, the product of w9 and a9, the product of w10 and a10, the product of w11 and a11, and the product of w12 and a12, which is shown in Equation (3).

Total quality level=w1*a1+w2*a2+w3*a3+w4*a4+w5*a5+w6*a6+w7*a7+w8*a8+w9*a9+w10*a10+w11*a11+w12*a12 (Equation 3)

The total quality level is a value obtained by multiplying positive weights by the respective item quality levels and adding the results of multiplication. The weights may be adjusted based on the degree of importance of the characteristic items. Consequently, an eye image having the highest total quality level is selected from among a plurality of eye images having item quality levels satisfying the reference quality level.

Next, the iris recognition unit will be described in detail.

The iris recognition unit performs iris recognition by using the image for iris recognition acquired by the eye image quality measurement unit described above. In the conventional techniques related to iris recognition, an iris zone is extracted from the image for iris recognition, an iris feature is extracted from the extracted iris zone, the extracted iris feature is coded, and the extracted iris feature is verified and identified through code comparison. A circular edge detection method, a Hough transform method, a template matching method, and the like may be used to extract an iris zone from an image for iris recognition. In recent years, the period of validity of the essential patent related to iris recognition, owned by Iridian in the USA, has expired, and various kinds of software using this technology have been developed.

In the present invention, therefore, any conventional techniques may be used as long as it is possible to satisfactorily extract an iris zone from an image for iris recognition, thereby successfully performing iris recognition. The conventional techniques related to iris recognition are well-known in the art to which the present invention pertains, and therefore a further detailed description thereof will be omitted.

In entrance security devices, such as door locks, into which an iris recognition technique has been introduced or into which much research on the introduction of an iris recognition technique has been conducted in recent years, other security devices, such as CCTVs, imaging devices, such as cameras, video players, and camcorders, and smart devices, such as smart phones, PDAs, PCs, and laptop computers, iris recognition may be performed using images for iris recognition in order to unlock the devices or to improve the security of the devices.

Next, the technical constructions of a method of acquiring an iris image for iris recognition by using a facial component distance according to an embodiment of the present invention will be described.

The method of acquiring the iris image for iris recognition according to the embodiment of the present invention includes the following steps (see FIG. 4).

The method of acquiring the iris image for iris recognition according to the embodiment of the present invention includes a step (S401) of the camera, which is in a standby state (hereinafter, referred to as a ‘sleep mode’), sensing the subject, starting to photograph a face image of the subject, and storing the photographed face image in the buffer, a step (S402) of the facial component distance calculation unit calculating the facial component distance from the face image stored in the buffer, a step (S403) of the actual distance estimation unit estimating the actual distance between the subject and the camera based on the calculated facial component distance and determining whether the subject is in the iris photographing volume, a step (S404) of, upon determining that the subject is in the iris photographing volume, the iris image acquisition unit acquiring eye images from the face image of the subject, dividing the acquired eye images into an eye image of the left eye and an eye image of the right eye and storing the divided eye images, and a step (S405) of measuring the quality of the eye images to acquire images for iris recognition that satisfy a reference quality level.

The detailed technical constructions of the above are the same as those described in connection with the system for acquiring the iris image for iris recognition by using the facial component distance described above, and therefore a detailed description thereof will be omitted.

Next, a method of calculating a facial component distance according to an embodiment of the present invention will be described.

The method of calculating the facial component distance according to the embodiment of the present invention includes the following steps (see FIG. 6).

The method of calculating the facial component distance according to the embodiment of the present invention includes a step (S601) of the element extraction unit extracting facial component elements from the face image stored in the buffer, a step (S602) of the face recognition unit determining whether to perform face recognition using the extracted facial component elements and, if so, performing face recognition using the extracted facial component elements, a step (S603) of the fake eye detection unit determining and detecting fake eyes through the performed face recognition, a step (S604) of the element distance measurement unit determining whether there are facial component elements the distances between which can be measured, among the extracted facial component elements, and, if so, measuring the distances between the facial component elements, and a step (S605) of the component distance calculation unit calculating the facial component distance from the measured distances between the facial component elements.

The detailed technical constructions of the above are the same as those described in connection with the system for acquiring the iris image for iris recognition by using the facial component distance described above, and therefore a detailed description thereof will be omitted.

Next, a method of estimating an actual distance according to an embodiment of the present invention will be described.

The method of estimating the actual distance according to the embodiment of the present invention includes the following steps.

The method of estimating the actual distance according to the embodiment of the present invention includes a step of calculating and estimating the actual distance between a subject and a camera using a function describing the relationship between the facial component distance and the actual distance between the subject and the camera acquired through prior experimentation and stored in a memory or a database of a computer or a terminal, including a smart phone, and a step of determining, from the actual distance between the subject and the camera estimated by the actual distance calculation unit, whether the subject is in an iris photographing volume.

The detailed technical constructions of the above are the same as those described in connection with the system for acquiring the iris image for iris recognition by using the facial component distance described above, and therefore a detailed description thereof will be omitted.

Next, a method of acquiring images for iris recognition according to an embodiment of the present invention will be described.

The method of acquiring the images for iris recognition according to the embodiment of the present invention includes the following steps (see FIG. 13).

The method of acquiring the images for iris recognition according to the embodiment of the present invention includes a step (1301) of the eye image extraction unit extracting eye images of the left eye and the right eye from the face image photographed in the iris photographing volume and stored in the buffer, a step (1302) of dividing the extracted eye images into an eye image of the left eye and an eye image of the right eye and storing the divided eye images in the eye image storage unit, a step (1303) of the eye image quality measurement unit measuring the quality of the stored eye images of the left eye and the right eye, and a step (1304) of the eye image quality measurement unit determining whether the measured quality of the eye images satisfies a reference quality level and, if so, acquiring the eye images the quality of which satisfies the reference quality level as images for iris recognition.

In addition, the method of acquiring the images for iris recognition according to the embodiment of the present invention may further include a step of performing iris recognition using images for iris recognition in order to unlock devices or to improve the security of the devices.

The detailed technical constructions of the above are the same as those described in connection with the system for acquiring the iris image for iris recognition by using the facial component distance described above, and therefore a detailed description thereof will be omitted.

Although all elements constituting the embodiments of the present invention are described so as to be integrated into a single one or to be operated as a single one, the present invention is not necessarily limited to such embodiments.

That is, all of the elements may be selectively integrated into one or more and be operated as one or more within the object and the scope of the present invention. In addition, each of the elements may be implemented as independent hardware. Alternatively, some or all of the elements may be selectively combined into a computer program having a program module performing some or all functions combined in one or more pieces of hardware.

A plurality of codes and code segments constituting the computer program may be easily reasoned by those skilled in the art to which the present invention pertains. The computer program may be stored in computer-readable media such that the computer program is read and executed by a computer to implement embodiments of the present invention. Computer program storage media may include magnetic recording media, optical recording media, and carrier wave media.

In addition, the term “comprises”, “includes”, or “has” used herein should be interpreted not to exclude other elements but to further include such other elements since the corresponding elements may be inherent unless mentioned otherwise.

All terms including technical or scientific terms have the same meanings as generally understood by a person having ordinary skill in the art to which the present invention pertains unless mentioned otherwise. Generally used terms, such as terms defined in a dictionary, should be interpreted as coinciding with meanings of the related art from the context.

### INDUSTRIAL APPLICABILITY

The present invention provides a system for acquiring an iris image for iris recognition by using a facial component distance, the system including a buffer for storing at least one face image of a subject photographed by a camera so as to acquire an image for iris recognition, a facial component distance calculation unit for calculating a facial component distance from the face image stored in the buffer, an actual distance estimation unit for estimating the actual distance between the subject and the camera from the facial component distance calculated by the facial component distance calculation unit and for determining based on the estimated distance whether the subject is in an iris photographing volume, and an iris image acquisition unit for acquiring an eye image from the face image of the subject determined to be in the iris photographing volume by the actual distance estimation unit and for measuring the quality of the acquired eye image to acquire an image for iris recognition that satisfies a reference quality level, and a method of acquiring an iris image for iris recognition by using a facial component distance, the method being performed by the system. Therefore, the industrial applicability of the present invention is very high.

### DESCRIPTIONS OF REFERENCE NUMERALS

301: Buffer
302: Facial component distance calculation unit
303: Actual distance estimation unit
304: Iris image acquisition unit
305: Face recognition unit
306: Iris recognition unit
501: Element extraction unit
502: Element distance measurement unit
503: Component distance calculation unit
504: Face recognition unit
505: Fake eye detection unit
701: Actual distance calculation unit
702: Iris photographing volume determination unit
1201: Eye image extraction unit
1202: Eye image storage unit
1203: Eye image quality measurement unit

1. A system for acquiring an iris image for iris recognition by using a facial component distance, the system comprising:
a buffer for storing at least one face image of a subject photographed by a camera so as to acquire an image for iris recognition;
a facial component distance calculation unit for calculating a facial component distance from the face image stored in the buffer;
an actual distance estimation unit for estimating an actual distance between the subject and the camera from the facial component distance calculated by the facial component distance calculation unit and for determining based on the estimated distance whether the subject is in an iris photographing volume; and
an iris image acquisition unit for acquiring an eye image from the face image of the subject determined to be in the iris photographing volume by the actual distance estimation unit and for measuring a quality of the acquired eye image to acquire an image for iris recognition that satisfies a reference quality level.

2. The system according to claim 1, wherein the face image is a photographed image of a portion or the entirety of the subject, comprising a face of the subject or an image obtained by cropping only a face zone from the image of the subject.

3. The system according to claim 1, wherein the facial component distance calculation unit comprises:
an element extraction unit for extracting facial component elements from the face image stored in the buffer;
an element distance measurement unit for determining whether there are facial component elements distances between which can be measured, among the extracted facial component elements and, if so, measuring the distances between the facial component elements the distances between which can be measured; and
a component distance calculation unit for calculating a facial component distance from the measured distances between the facial component elements.

4. The system according to claim 3, wherein the element extraction unit partially or entirely extracts at least one selected from among eyes (a left eye and a right eye), eyebrows (a left eyebrow and a right eyebrow), a nose, nostrils (a left nostril and a right nostril), a mouth, ears, jaws, cheeks, and a face boundary as the facial component elements.

5. The system according to claim 3, wherein the element distance measurement unit measures the distances between the extracted facial component elements and then uses some or all of the measured distances between the facial component elements.

6. The system according to claim 5, wherein the distances between the facial component elements are obtained by measuring pixel distances between the facial component elements in the face image photographed by the camera.

7. The system according to claim 5, wherein the distances between the facial component elements differ based on positions of reference points at which measurement is performed.

8. The system according to claim 5, wherein the distance between the left eye and the right eye, which is one of the distances between the facial component elements, uses at least one selected from among an interpupillary distance, an intercanthal distance, a distance between outsides of pupils, and a biectocanthal distance as a reference point.

9. The system according to claim 3, wherein the component distance calculation unit calculates the facial component distance differently based on a number of the distances between the facial component elements, measurable by the element distance measurement unit.

10. The system according to claim 9, wherein, in a case in which two or more distances between the facial component elements are given, one of the two or more distances between the facial component elements is selected, the two or more distances between the facial component elements are simultaneously used as calculation factors, or the two or more distances between the facial component elements are calculated into a single value, so as to be used as the facial component distance.

11. The system according to claim 10, wherein, in a case in which one of the two or more distances between the facial component elements is to be selected, a distance between the facial component elements that can be most easily measured is selected so as to be used as the facial component distance, and, in a case in which the two or more distances between the facial component elements can be measured with the same ease, one is randomly selected from among the two or more distances between the facial component elements so as to be used as the facial component distance.

12. The system according to claim 10, wherein, in a case in which two or more distances between the facial component elements are given and are simultaneously used as calculation factors, the distances between the facial component elements are expressed in a form of a sequence pair, a matrix, or a vector so as to be used as the facial component distance.

13. The system according to claim 10, wherein, in a case in which two or more distances between the facial component elements are given and are to be calculated into a single distance, the two or more distances between the facial component elements is calculated into a single value by using a multivariable regression function so as to be used as the facial component distance.

14. The system according to claim 1, wherein the actual distance estimation unit comprises:
an actual distance calculation unit for calculating and estimating the actual distance between the subject and the camera using a function describing a relationship between the facial component distance and the actual distance between the subject and the camera stored in a memory or a database of a computer or a terminal; and
an iris photographing volume determination unit for determining, from the estimated actual distance between the subject and the camera, whether the subject is in the iris photographing volume.

15. The system according to claim 14, wherein the function indicates the relationship between the facial component distance and the actual distance between the subject and the camera, obtained by changing the actual distance between the subject and the camera, and is obtained by using a statistical means.

16. The system according to claim 15, wherein the statistical means used to obtain the function comprises regression analysis using the facial component distance as an independent variable and the actual distance between the subject and the camera as a dependent variable.

17. The system according to claim 14, wherein the function is equally used for all users or is differently used for respective users through calibration.

18. The system according to claim 17, wherein the calibration is performed in consideration of characteristics of the camera and a sensor or an age of the subject.

19. The system according to claim 1, wherein a predetermined margin distance is added before entry into a capture volume or after exit from the capture volume such that the iris photographing volume is set to be larger than the capture volume.

20. The system according to claim 1 wherein a predetermined margin time is added before entry into a capture volume or after exit from the capture volume such that the iris photographing volume is set to be larger than the capture volume.

21. The system according to claim 19, wherein the margin distance is set based on a minimum number of face images necessary to acquire images for iris recognition, a number of eye images acquired from the face images, or a number of eye images that satisfy the reference quality level.

22. The system according to claim 14, wherein the iris photographing volume determination unit comprises an intuitive image guide unit for providing an intuitive image guide such that the subject is in the iris photographing volume.

23. The system according to claim 22, wherein the intuitive image guide uses an image based on at least one selected from among a size, sharpness, and color of the face image.

24. The system according to claim 23, wherein the image based on the size of the face image is configured such that the size of the face image of the subject is increased as the distance between the camera and the subject is decreased and such that the size of the face image of the subject is decreased as the distance between the camera and the subject is increased.

25. The system according to claim 23, wherein the image based on the sharpness of the face image is configured such that a blurry image is provided when the subject is not in the iris photographing volume and such that a sharp image is provided when the subject is in the iris photographing volume.

26. The system according to claim 23, wherein the image based on the color of the face image is configured such that the face image is provided with a background color preventing the subject from being recognized when the subject is not in the iris photographing volume and such that the face image is provided without a change of color when the subject is in the iris photographing volume.

27. The system according to claim 22, wherein at least one selected from among a means for generating an auditory signal, such as sound or voice, a means, such as a light emitting diode (LED) or a flash, for generating a visual signal, and a means for generating vibration is added to the intuitive image guide.

28. The system according to claim 14, wherein the iris photographing volume determination unit is configured such that an entirety of the camera, a camera lens, or a camera sensor moves back and forth to photograph the face image so as to locate the subject in the iris photographing volume in a state in which the subject is stationary.

29. The system according to claim 1, wherein the iris image acquisition unit comprises:
an eye image extraction unit for extracting eye images of a left eye and a right eye from the face image photographed in the iris photographing volume and stored in the buffer;
an eye image storage unit for dividing the eye images extracted by the eye image extraction unit into an eye image of the left eye and an eye image of the right eye and storing the divided eye images; and
an eye image quality measurement unit for measuring a quality of the eye images of the left eye and the right eye stored in the eye image storage unit, determining whether the measured quality of the eye images satisfies the reference quality level, and, if so, acquiring eye images the quality of which satisfies the reference quality level as images for iris recognition.

30. The system according to claim 29, wherein, in a case in which the iris photographing volume is equal to a capture volume, the eye image extraction unit crops an eye zone from the face image photographed in the iris photographing volume and uses the cropped face image as an eye image.

31. The system according to claim 29, wherein, in a case in which the iris photographing volume is larger than a capture volume, the eye image extraction unit simultaneously or separately crops an eye zone from the face image photographed in the capture volume and uses the cropped face image as an eye image.

32. The system according to claim 30, wherein the eye zone comprises a portion or an entirety of an eye necessarily comprising an iris zone.

33. The system according to claim 30, wherein the eye zone is cropped in a predetermined shape selected from among a quadrangular shape, a circular shape, and an oval shape.

34. The system according to claim 30, wherein a plurality of face images is automatically photographed in the iris photographing volume at a predetermined speed without informing the subject of the automatic photographing.

35. The system according to claim 30, wherein a volume for allowing the eye image to be acquired is limited to the capture volume so as to optimize power and resource efficiency.

36. The system according to claim 29, wherein the eye image storage unit logically or physically divides and stores the eye images of the left eye and the right eye.

37. The system according to claim 36, wherein, in order to logically divide and store the eye images of the left eye and the right eye, a single physical space for storing eye images is logically divided into a space for storing eye images of the left eye and a space for storing eye images of the right eye such that the eye images of the left eye and the eye images of the right eye can be separately stored in different logical spaces.

38. The system according to claim 36, wherein, in order to physically divide and store the eye images of the left eye and the right eye, a physical space for storing eye images of the left eye and a physical space for storing eye images of the right eye are separately provided such that the eye images of the left eye and the eye images of the right eye can be separately stored in different physical spaces.

39. The system according to claim 29, wherein the eye image quality measurement unit separately measures the quality of the eye images of the left eye and the right eye.

40. The system according to claim 29, wherein items of which the quality is measured comprise a quality item necessary to select general images having no relations with iris characteristics and a quality item related to the iris characteristics.

41. The system according to claim 40, wherein the quality item necessary to select general images having no relations with the iris characteristics comprises at least one selected from among a sharpness, a contrast ratio, and a noise level, and wherein the quality item related to the iris characteristics comprises at least one selected from among a capture range of an iris zone, a light reflection degree, a position of an iris, a sharpness of an iris, a contrast ratio of an iris, a noise level of an iris, a sharpness of an iris boundary, a contrast ratio of an iris boundary, and a noise level of an iris boundary.

42. The system according to claim 29, wherein the eye image quality measurement unit selects a pair of images for iris recognition comprising eye images of the left eye and the right eye that satisfies the reference quality level from among the eye images of the left eye and the right eye, the quality of which has been measured separately.

43. The system according to claim 42, wherein, in a case in which there is no eye image of the left eye that satisfies the reference quality level or in a case in which there is no eye image of the right eye that satisfies the reference quality level, the system discards all of the eye images of the left or right eye and then requests acquisition of new eye images.

44. The system according to claim 42, wherein, in a case in which there are neither eye image of the left eye that satisfies the reference quality level nor eye image of the right eye that satisfies the reference quality level, the system discards all of the eye images of the left and right eyes and then requests acquisition of new eye images.

45. The system according to claim 42, wherein, in a case in which there is a plurality of eye images of the left eye and the right eye that satisfies the reference quality level, the system selects one of the eye images having a highest total quality level.

46. The system according to claim 45, wherein the total quality level is measured through weighted addition set by Equation (3).
Total quality level=w1*a1+w2*a2+w3*a3+w4*a4+w5*a5+w6*a6+w7*a7+w8*a8+w9*a9+w10*a10+w11*a11+w12*a12 (Equation 3)
Assuming that a numerical value of sharpness of an image is a1, a weight of which is w1, a numerical value of a contrast ratio of an image is a2, a weight of which is w2, a numerical value of a noise level of an image is a3, a weight of which is w3, a numerical value of a capture range of an iris zone is a4, a weight of which is w4, a numerical value of a light reflection degree is a5, a weight of which is w5, a numerical value of a position of an iris is a6, a weight of which is w6, a numerical value of sharpness of an iris is a7, a weight of which is w7, a numerical value of a contrast ratio of an iris is a8, a weight of which is w8, a numerical value of a noise level of an iris is a9, a weight of which is w9, a numerical value of sharpness of an iris boundary is a10, a weight of which is w10, a numerical value of a contrast ratio of an iris boundary is a11, a weight of which is w11, and a numerical value of a noise level of an iris boundary is alt, a weight of which is w12, the total quality level is a value obtained by adding a product of w1 and a1, a product of w2 and a2, a product of w3 and a3, a product of w4 and a4, a product of w5 and a5, a product of w6 and a6, a product of w7 and a7, a product of w8 and a8, a product of w9 and a9, a product of w10 and a10, a product of w11 and a11, and a product of w12 and a12.

47. The system according to claim 1, further comprising a face recognition unit for performing face recognition during calculation of the facial component distance.

48. The system according to claim 1, further comprising a fake eye detection unit for preventing fake face images from being acquired using a fake face detection technique and an eye-tracking technique in a face recognition field.

49. The system according to claim 29, further comprising an iris recognition unit for performing iris recognition so as to unlock a device or to improve the security of the device by using the acquired images for iris recognition.

50. The system according to claim 1, further comprising a means for turning off visible lighting and turning on infrared lighting in the iris photographing volume or a means having an infrared bandpass filter located in front of visible lighting in order to transmit only infrared rays in a case in which the visible lighting is turned on.

51. A method of acquiring an iris image for iris recognition by using a facial component distance, the method comprising:
a camera, which is in a standby state, sensing a subject, starting to photograph a face image of the subject, and storing the photographed face image in a buffer;
calculating a facial component distance from the face image stored in the buffer;
estimating an actual distance between the subject and the camera based on the calculated facial component distance and determining whether the subject is in an iris photographing volume; and
upon determining that the subject is in the iris photographing volume, acquiring eye images from the face image of the subject and measuring a quality of the acquired eye images to acquire images for iris recognition that satisfy a reference quality level.

52. The method according to claim 51, wherein the operation of calculating the facial component distance from the face image stored in the buffer comprises:
extracting facial component elements from the face image stored in the buffer;
determining whether there are facial component elements distances between which can be measured, among the extracted facial component elements, and, if so, measuring the distances between the facial component elements; and
calculating the facial component distance from the measured distances between the facial component elements.

53. The method according to claim 52, further comprising determining whether to perform face recognition using the extracted facial component elements and, if so, performing face recognition using the extracted facial component elements.

54. The method according to claim 53, wherein the operation of determining whether to perform the face recognition and, if so, performing the face recognition comprises determining and detecting fake eyes using a fake eye detection unit.

55. The method according to claim 51, wherein the operation of estimating the actual distance between the subject and the camera based on the calculated facial component distance and determining whether the subject is in the iris photographing volume comprises:
calculating and estimating the actual distance between the subject and the camera using a function describing a relationship between the facial component distance and the actual distance between the subject and the camera stored in a memory or a database; and
determining, from the actual distance between the subject and the camera estimated at the above operation, whether the subject is in the iris photographing volume.

56. The method according to claim 51, wherein the operation of, upon determining that the subject is in the iris photographing volume, acquiring the eye images from the face image of the subject and measuring the quality of the acquired eye images to acquire the images for iris recognition that satisfy the reference quality level comprises:
extracting eye images of a left eye and a right eye from the face image photographed in the iris photographing volume and stored in the buffer;
separately storing the extracted eye images of the left eye and the right eye;
measuring a quality of the stored eye images of the left eye and the right eye; and
determining whether the measured quality of the eye images satisfies the reference quality level and, if so, acquiring the eye images the quality of which satisfies the reference quality level as images for iris recognition.

57. The method according to claim 56, further comprising performing iris recognition so as to unlock a device or to improve the security of the device by using the acquired images for iris recognition.

58. A recording medium loaded in a computer or a terminal so as to perform a method of acquiring an iris image for iris recognition by using a facial component distance, the method comprising:
a camera, which is in a standby state, sensing a subject, starting to photograph a face image of the subject, and storing the photographed face image in a buffer;
calculating a facial component distance from the face image stored in the buffer;
estimating an actual distance between the subject and the camera based on the calculated facial component distance and determining whether the subject is in an iris photographing volume; and
upon determining that the subject is in the iris photographing volume, acquiring eye images from the face image of the subject and measuring a quality of the acquired eye images to acquire images for iris recognition that satisfy a reference quality level, wherein the recording medium has a computer-readable or terminal-readable program for executing operations of the method of acquiring the iris image for iris recognition by using the facial component distance written therein.
